(19) United States
(12) Patent Application Publication
(10) Pub. No.: US 2025/0266026 A1
(43) Pub. Date: Aug. 21, 2025

(54) Sound-Attenuating Device and Method of Use Thereof

(71) Applicants: Olivia Washburn, Orem, UT (US); Stephen Washburn, Orem, UT (US); Melissa Washburn, Orem, UT (US)

(72) Inventors: Olivia Washburn, Orem, UT (US); Stephen Washburn, Orem, UT (US); Melissa Washburn, Orem, UT (US)

(21) Appl. No.: 19/063,287

(22) Filed: Feb. 25, 2025

Related U.S. Application Data
(63) Continuation of application No. 18/132,964, filed on Apr. 10, 2023, now Pat. No. 12,236,930.
Application No. 18/132,964 is a continuation of application No. 17/151,579, filed on Jan. 18, 2021, now abandoned.
Application No. 17/151,579 is a continuation-in-part of application No. 16/373,646, filed on Apr. 3, 2019, now Pat. No. 10,897,666.
(60) Provisional application No. 62/652,238, filed on Apr. 3, 2018.
(60) Provisional application No. 62/826,994, filed on Mar. 30, 2019.

(51) Int. Cl. G10K 11/168; A42B 1/06; H04R 1/10; H04R 5/033

(52) U.S. Cl. CPC G10K 11/168; A42B 1/06; H04R 1/1008; H04R 1/1058; H04R 1/1083; H04R 1/1091; H04R 5/0335; H04R 2460/15

(57) ABSTRACT

A sound-attenuating assembly may have a headpiece and two covered dampening assembly that may be detachably attached to the locations of the headpiece that oppose a wearer's ear; the dampening assembly may have a padded member member that may be in contact with a dividing member that may be in a contact with a compressible member which may be disposed within a concave member; the dampening assembly may be disposed within a cover such a fastener of the cover detachably attaches to a fastener of the headpiece.

### CROSS-REFERENCE TO RELATED APPLICATIONS

This application is a continuation-in-part of U.S. patent application Ser. No. 18/132,964, entitled Sound-Attenuating Device and Method of Use Thereof, which was filed on Apr. 10, 2023. U.S. patent application Ser. No. 18/132,964 is a continuation of U.S. patent application Ser. No. 17/151,579, which was filed on 2021 Jan. 8, which is a continuation-in-part of U.S. patent application Ser. No. 16/373,646, which was filed on 2019 Apr. 3 (and was issued as U.S. patent Ser. No. 10/897,666, which was issued on 2021 Jan. 19), which claimed the benefit of the following two Provisional Patent Applications: 1) U.S. Provisional Patent Application No. 62/826,994, which was filed on 2019 Mar. 30, and 2) U.S. Provisional Patent Application No. 62/652,238, which was filed on 2018 Apr. 3. The benefit of priority to the filing dates of these applications is hereby claimed. The subject matter of all of these applications is expressly incorporated herein by reference in their entirety for all purposes.

### BACKGROUND OF THE INVENTION

### The Field of the Invention

The present invention relates generally to sound attenuating devices for ears, and more specifically to a sound attenuating device for a neonatal device; certain embodiments may be used for individuals who are greater in age than an infant such as a child, adolescent, or adult.

The figures are illustrative, give examples, and are not supposed to be limiting. First 15 pages of drawings deleted due to space issues.

### 2. Background

When an infant is in the womb, it is protected from potentially damaging ambient noise by the mother's body. More specifically, the mother's body suppresses sound by approximately 15 dB in the mid to high frequency range. Such sound protection is especially important during the last trimester, since auditory neural pathways begin to form at that time. The auditory neural pathways develop gradually with the infant in the womb 19-27 weeks being able to respond to 500 Hz and attenuate sound below 500 Hz; an infant 33-40 weeks being able to respond to 1000 Hz and attenuate sound below 1000 Hz; and an infant full term being able to respond to 400-4000 Hz and attenuate sounds below 4000 Hz. “The period from 25 weeks' gestation to 5 to 6 months of age is most critical to the development of the neurosensory part of the auditory system.” (Stanley N. Graven & Joy V. Browne, Auditory Development in the Fetus and Infant, 8 Newborn and Infant Nursing Reviews 187 (2008)). Unfortunately, some infants are born prematurely and must be maintained in a neonatal intensive care unit (NICU) of a hospital. Because of the nature of the NICU, much noise throughout the frequency spectrum is generated from the activity of nurses, phones, bells, alarms, etc. Noise levels in the NICU may range from 60 dB to 120 dB; 60 dB is around the sound level of normal conversation, and 120 dB may be the level of an ambulance siren. Sound levels in the NICU may be above the safe range for infants over 70% of the time. Such noises may adversely affect the infant in many ways, such as by leading to stress which may lead to tachycardia and hypoxia. Such an exposure may lead to long term issues such as Auditory Processing Disorder, and infants that spend time in the NICU are more likely to develop learning disabilities. For example, the infant's reactions to the stress burns many calories, thus potentially adversely affecting its growth during a critical phase of its life. The noise may keep the infant from getting much needed sleep, and, if antibiotics are administered to the infant, the noise could promote antibiotic attack on sensory mechanisms in the auditory system. Thus, protecting neonatal infants from harmful sounds which arise in the NICU environment is very desirable. On the other hand, since auditory neural pathways are being formed at that time, it is not desirable to attenuate too much sound, because overly isolating the infant from sound may inhibit neural development.

At this point in time, certain devices have been disclosed or published, such as U.S. Pat. No. 5,243,709; US Pat Appl. Pub. 2018/0177641; US20130046219A1; US20130133671A1; US20090178177A1; and, US20100014686A1.

### SUMMARY OF INVENTION

### Brief Description of the Drawings

The preferred embodiments of the present invention will be described in conjunction with the appended drawings. Various sizes and shapes and configurations of the parts of the mountable watering assembly are contemplated; various sizes of fasteners may be used depending on size and spacing of the rails of a railing system, such as a railing system that may be installed on a deck. Like designations denote like elements, and (APPLICANT WITHDRAWS THE FIRST 15 PAGES OF THE DRAWINGS DUE TO FILE SIZE ISSUES):

FIG. 1A depicts a perspective view of an embodiment of a concave member 102.

FIG. 1B shows a side view of the embodiment shown in FIG. 1A.

FIG. 1C shows a top view of the embodiment shown in FIG. 1A.

FIG. 2A shows a perspective view of an embodiment of a compressible member.

FIG. 2B shows a top view of the compressible member of FIG. 2A.

FIG. 3A shows a perspective view of an embodiment of a dividing member 106.

FIG. 3B shows a top view of the embodiment of shown in FIG. 3A.

FIG. 3C shows a side view of the embodiment of shown in FIG. 3A.

FIG. 4A depicts an embodiment of a padded member.

FIG. 4B depicts a top view of the embodiment of shown in FIG. 4A.

FIG. 5A depicts a side view of a dampening assembly.

FIG. 5B depicts a perspective view of the embodiment of shown in FIG. 5A.

FIG. 6 depicts an exploded view of the embodiment of shown in FIG. 5A.

FIG. 7A depicts a first front cover.

FIG. 7B depicts a second front cover.

FIG. 8 depicts a back cover.

FIG. 9 depicts a back view of a covered dampening assembly.

FIG. 10 depicts a front view of the covered dampening assembly of FIG. 9.

FIG. 11 depicts a first front piece of a headpiece 113.

FIG. 12 depicts a second front piece of a headpiece 113.

FIG. 13 depicts a first back piece of a headpiece 113.

FIG. 14 depicts a second back piece of a headpiece 113.

FIG. 15 depicts an embodiment of a headpiece 113.

FIG. 16 depicts the embodiment of the headpiece 113 of FIG. 15 being worn by an infant.

FIG. 17A depicts the front view of the headpiece 113 of FIG. 15.

FIG. 17B depicts a back view of the headpiece 113 of FIG. 15.

FIG. 18A depicts a perspective view of an embodiment of a headpiece 113.

FIG. 18B depicts a front view of the embodiment of the headpiece 113 of FIG. 18A.

FIG. 19 depicts a partial perspective view of the embodiment of the headpiece 113 of FIG. 18A.

FIG. 20 depicts an embodiment of a covered dampening assembly.

FIG. 21 depicts an embodiment of the covered dampening assembly of FIG. 20.

FIG. 22A depicts a perspective back view of the embodiment shown in FIG. 18A.

FIG. 22B shows a top view of the embodiment shown in FIG. 18A.

FIG. 23 shows a partial view of the embodiment of FIG. 18 as well as a perspective back view of a covered dampening assembly.

FIG. 24 shows an infant wearing the embodiment of the headpiece shown in FIG. 18A.

FIG. 25A shows an embodiment of a side view of what is shown in FIG. 24.

FIG. 25B shows an embodiment of a side perspective view of what is shown in FIG. 25A;

FIG. 25C shows an embodiment of a front-side perspective view of what is shown in FIG. 25B.

FIG. 25D shows an embodiment of a back view of what is shown in FIG. 25C.

FIG. 25E shows an embodiment of a frontal upward facing view of what is shown in FIG. 25D.

FIG. 26A depicts an embodiment of the sound-attenuating earpiece assembly.

FIG. 26B depicts an embodiment of a portion of the sound-attenuating earpiece assembly.

FIG. 26C depicts an embodiment of a portion of the sound-attenuating earpiece assembly.

FIG. 26C depicts an embodiment of a portion of the sound-attenuating earpiece assembly.

FIG. 26D depicts a top view of the embodiment of the sound-attenuating earpiece assembly 800 shown in FIG. 26A.

FIG. 26E depicts a bottom view of the embodiment shown in FIG. 26A.

FIG. 26F depicts the button as an embodiment of the earpiece assembly shown in FIG. 26A.

FIG. 27A depicts an embodiment of the second dampening layer earpiece dampening assembly

FIG. 27B depicts an embodiment of the second dampening layer.

FIG. 27C depicts a top-oblique view of the second dampening layer and the button of the embodiment shown in FIG. 27B.

FIG. 28 depicts an embodiment of a behind-the-head headband without earpieces coupled to it.

FIG. 29A depicts an embodiment of a behind-the-head headband with 2 earpieces coupled to it.

FIG. 29B depicts an infant wearing the embodiment as shown in FIG. 29A.

FIG. 29C depicts an infant wearing the headband with the earpieces attached as shown in FIG. 29A, with the headband oriented so it is on top portion of the head.

FIG. 30 depicts an infant wearing the embodiment shown in FIG. 29B with an attached forehead strap 908.

FIG. 31 depicts the side view of an embodiment of the headband shown in FIG. 29A that is adjustable in size.

FIG. 32A depicts an embodiment of a full circular headband.

FIG. 32B depicts an infant wearing the embodiment shown in FIG. 32A.

FIG. 33A: depicts the top view of an earpiece 1000 that can be swapped out to allow the headband shown in the figures above to attenuate different amounts of sound.

FIG. 33B: depicts the bottom view of FIG. 33A

FIG. 33C depicts the perspective view of FIG. 33A

FIG. 34 depicts the button 1101.

FIG. 35 depicts a cross section of FIG. 33A.

FIG. 36 an embodiment of FIG. 35 where there is only one type of attenuating material.

FIG. 37 depicts an embodiment of FIG. 35 where the inner attenuating material 1105 is made of a composite of materials 1100 and 1104.

FIG. 38 depicts a number of different embodiments of the ear piece 1000 with different sizes and attenuation amounts.

FIG. 39A depicts another embodiment of the ear piece 1000 from the top.

FIG. 39B depicts the bottom view of FIG. 39A.

FIG. 39C depicts a perspective view of FIG. 39A.

FIG. 40 depicts a cross-section view of an embodiment of the earpiece 2000 shown in FIG. 39A.

FIG. 41A depicts just the padding member 2102 and the button 2100.

FIG. 41B depicts what is shown in FIG. 41A, but where the button and the padding member are the same piece.

FIG. 42A depicts one type of layer used in the ear piece 2000. This layer may be made up of one type of attenuating material.

FIG. 42B depicts what is shown in FIG. 42A but from a cross-section view.

FIG. 42C depicts a bottom view of FIG. 42A.

FIG. 42D depicts a top view of FIG. 42A.

FIG. 43A depicts another embodiment of the attenuating layers used in the ear piece 2000. This type of layer is made up of 2 or more different materials with one of them being on the outside, and the others are embedded inside the outer layer

FIG. 43B depicts a cross section of FIG. 43A where 2224 is the inner material and 2222 is the outer material.

FIG. 43C depicts the bottom view of FIG. 43A.

FIG. 43D depicts the top view of FIG. 43A.

FIG. 44A depicts a third embodiment of the attenuating layers used in the ear piece 2000. In this embodiment, each layer is composed of 2 sublayers. Each sublayer may be a different attenuating material. For example, 2224 might be a compressible material and 2242 might be silicone.

FIG. 44B. depicts a cross section of this embodiment in FIG. 44A.

FIG. 44C. depicts a bottom view of FIG. 44A.

FIG. 44D. depicts a top view of FIG. 44A.

FIG. 45A depicts another embodiment of the earpiece from the top.

FIG. 45B depicts a cross section of the earpiece from 45A. In this embodiment, the button 3100 and the outer attenuating layer 3106 are coupled together and detachably coupled to the inner attenuating layer 3104 and the padding attenuating member 3102. For this embodiment the outer layer 3106 is supposed to be permanent, while the inner layer 3104 and 3102 can be replaced. They are coupled temporarily using an adhesive, friction, or a magnet, or other method to couple them together temporarily.

FIG. 45C depicts a perspective view of FIG. 45A.

FIG. 45D depicts the bottom view of FIG. 45A.

FIG. 46A shows the outer layer detached from the inner layer.

FIG. 46B shows the inner layer detached from the outer layer. In practice, the object shown in FIG. 46B will be removed and may have different attenuating properties. Swapping it out can change the attenuating properties of the headpiece.

FIG. 47 shows a perspective view of the adjustable headband 960 shown in FIG. 31.

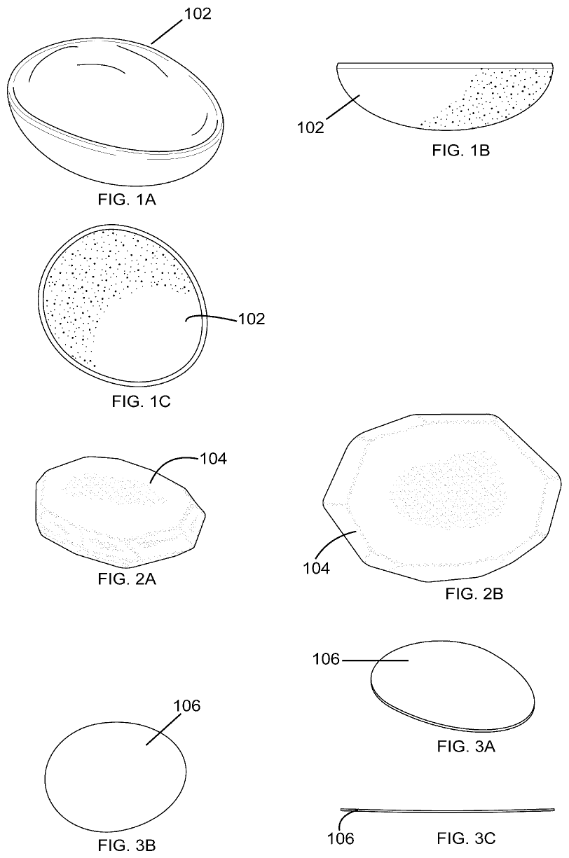

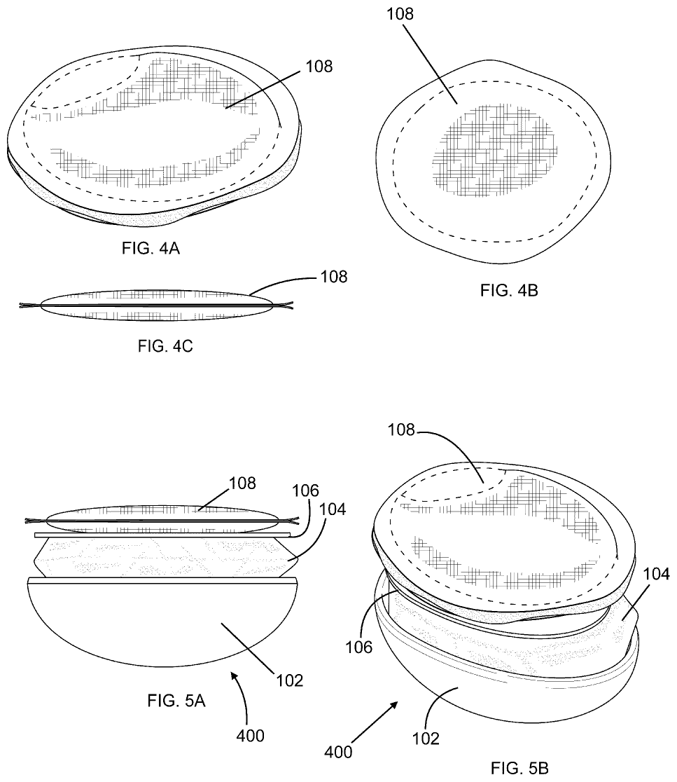

### DETAILED DESCRIPTION OF EMBODIMENTS OF THE INVENTION

In this disclosure the following figures, which will first be discussed may be deemed by some to be the focus of this disclosure; after discussing figures with greater figure numbers, a discussion concerning the figures with lesser figure numbers will then occur so as to provide additional context.

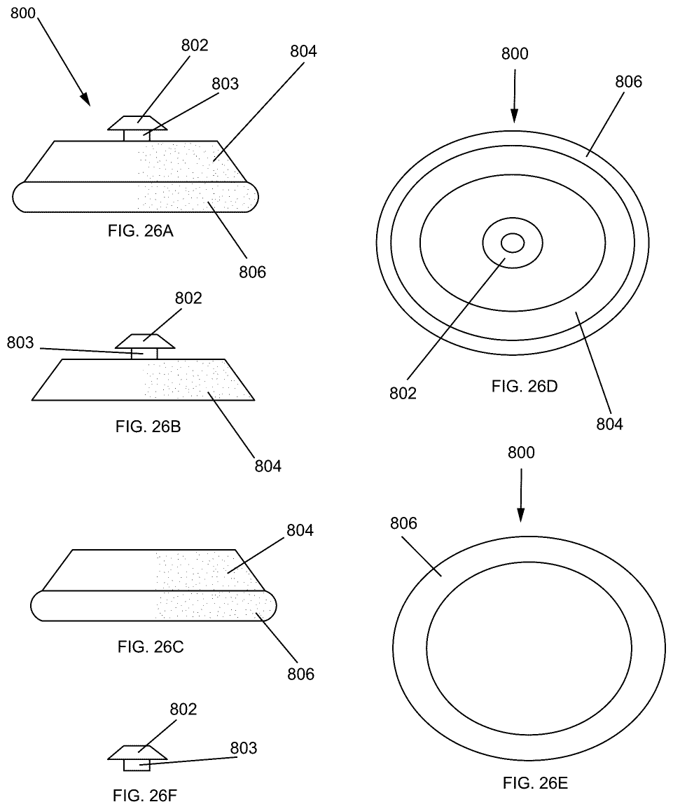

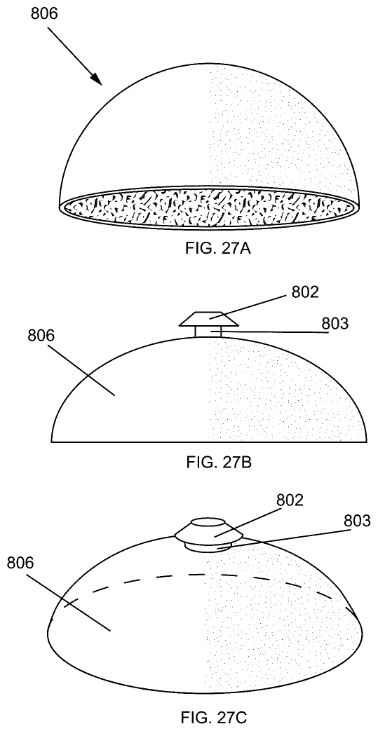

Referring to FIG. 26A, which depicts an embodiment of the sound-attenuating earpiece assembly 800. Referring to FIG. 26A, which depicts an embodiment of the sound-attenuating earpiece assembly 800. The sound-attenuating earpiece assembly 800 may be rotatable around the button stem 803 when the sound-attenuating earpiece assembly 800 is coupled to a headpiece 900.

Referring to FIG. 26B, which depicts a portion of the sound-attenuating earpiece assembly 800, which may include an embodiment of the first dampening layer 804, which may be comprised of silicone material, disposed below an embodiment of a button 802 of some embodiments of an earpiece dampening assembly, wherein the button 802 may comprise a button stem 803 extending from a buttonhead.

Referring to FIG. 26C, which depicts a portion of the sound-attenuating earpiece assembly 800 comprising the first dampening layer 804 coupled to the second dampening layer 806; in some embodiments the first dampening layer 804 is a silicone layer, and in some embodiments the second dampening layer 806 is viscoelastic foam layer configured to be detachably coupled to a neonatal user; the second dampening layer 806 may be one of the following: round, ring-shaped, arcuate, rectangular, oval, circular, or elliptical and may be two or more of the following when geometrically possible: round, ring-shaped, arcuate, rectangular, oval, circular, or elliptical. A second dampening layer 806 may be coupled to the first dampening layer 804 and the first dampening layer 804 may be disposed between the second dampening layer 806 and the button 802.

Referring to FIG. 26D, which depicts a top view of the embodiment of the sound-attenuating earpiece assembly 800 shown in FIG. 26A. The second dampening layer 806 of the sound-attenuating earpiece assembly 800 may stretch further in the radial direction than the first dampening layer 804. The button 802 may be positioned in the center and extended radially outward.

Referring to FIG. 26E, which depicts a bottom view of the embodiment shown in FIG. 26A. Here, an embodiment of the second dampening layer 806 is depicted as the outside layer of the sound-attenuating earpiece assembly 800 and may be round, ring-shaped, arcuate, rectangular, oval, circular, or elliptical and may be two or more of the following when geometrically possible: round, ring-shaped, arcuate, rectangular, oval, circular, or elliptical.

Referring to FIG. 26F, which depicts the button as an embodiment of the earpiece assembly shown in FIG. 26A. In the earpiece dampening assembly the button comprises two parts: the button head 802 and button stem 803. The button head 802 may taper from the top to the bottom where the bottom is larger than the top until it attaches to the button stem 803; the button head 802 may be round, ring-shaped, arcuate, rectangular, oval, circular, or elliptical and may be two or more of the following when geometrically possible: round, ring-shaped, arcuate, oval, circular, or elliptical. The button stem 803 is narrower than the bottom of the button 802 and connects to the bottom of the button 802 and may be round, ring-shaped, arcuate, rectangular, oval, circular, or elliptical and may be two or more of the following when geometrically possible: round, ring-shaped, arcuate, oval, circular, or elliptical.

Referring to FIG. 27A, which depicts an embodiment of the second dampening layer earpiece dampening assembly 806, which may be comprised of outer silicone layer. The second dampening layer earpiece dampening assembly 806 may be half of a sphere, oval shaped, rounding, or rectangular with a flat surface on the bottom.

Referring to FIG. 27B, which depicts an embodiment of the second dampening layer 806 coupled to the button 802.

Referring to FIG. 27C, which depicts a top-oblique view of the second dampening layer 806 and the button 802 of the embodiment shown in FIG. 27B.

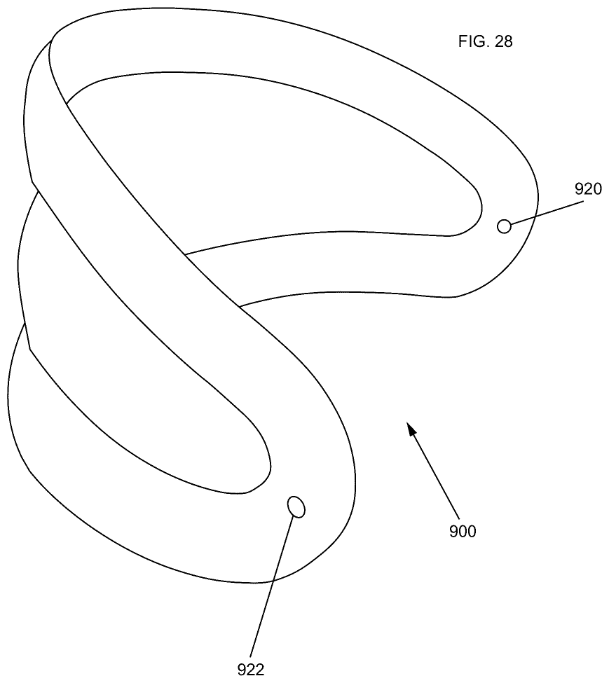

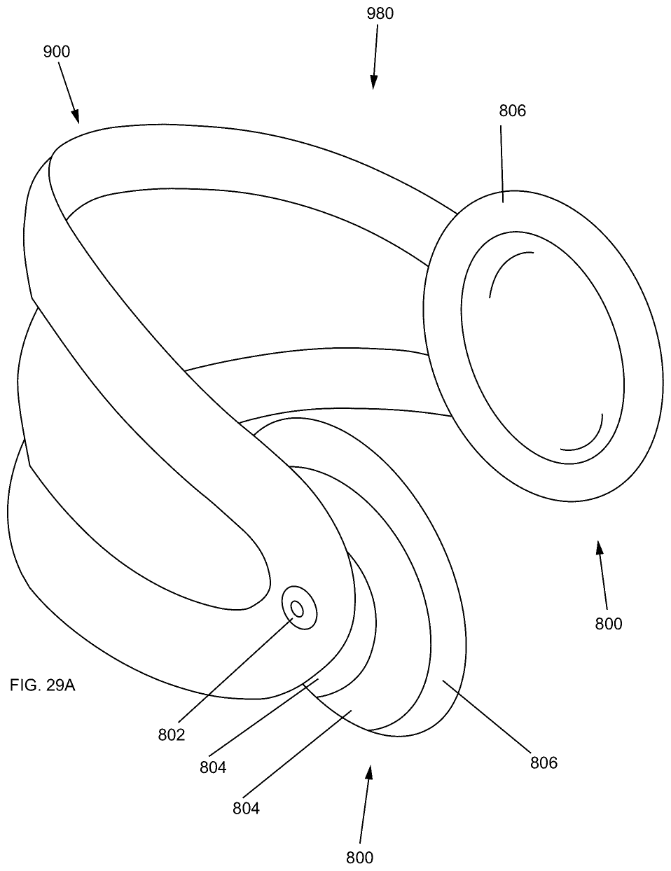

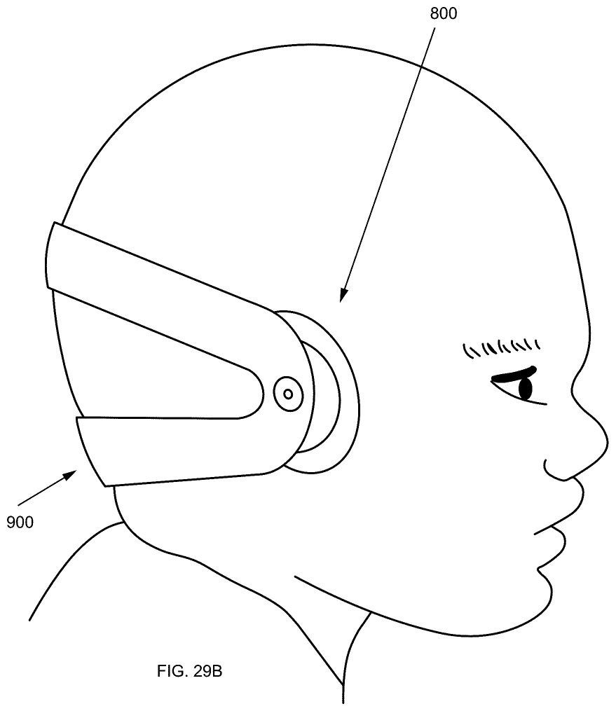

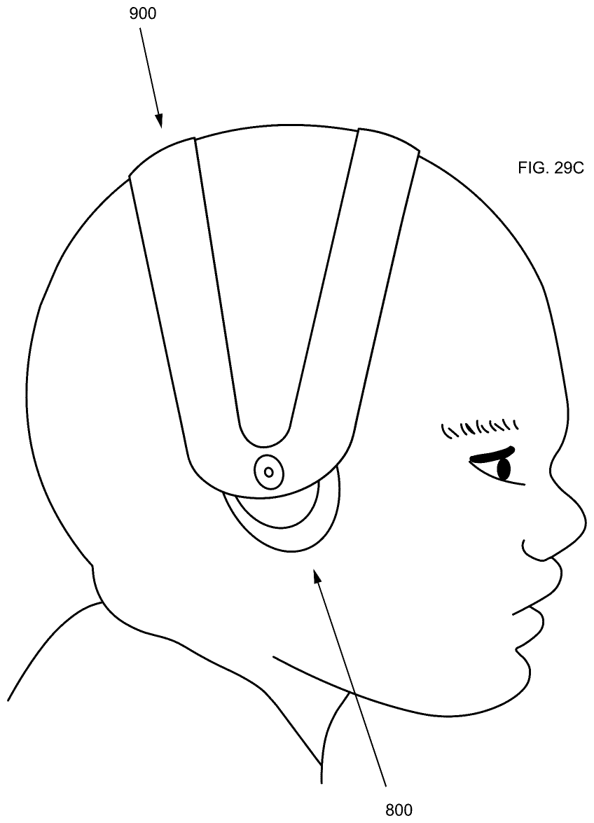

Referring to FIG. 28, which depicts an embodiment of a behind-the-head headband 900 without earpieces coupled to it. The headband 900 may have an attachment hole over left ear 920 positioned at the end of the left side of the headband 900, and an attachment hole over the right ear 922 positioned at the end of the right side of the headband 900. These attachment holes 920 and 922 may be used to receive the button 802. The button 802 may latch in such a way that allows the user to adjust the positioning of the headband 900 while keeping the earpiece 800 stationary.

Referring to FIG. 29A, which depicts an embodiment of FIG. 28 attached to two 2 earpieces. The embodiment of a behind-the-head headband attaches to an earpiece through a hole element 922 (see FIG. 28) defining a hole in the headband 900 past the top of the button 802 to rest on the button stem 803. The hole 922 (see FIG. 28) is slightly smaller than the bottom of the button 802 and slightly larger than the width of the button stem 803.

FIG. 29B depicts an infant wearing the headband 900 with the earpiece assembly 800 without the forehead strap 908 and the headband on the back of the head of the infant.

Referring to FIG. 29C, which depicts an infant wearing the headband with the ear pieces attached shown in FIG. 29A, with the headband oriented so it is on top portion of the head.

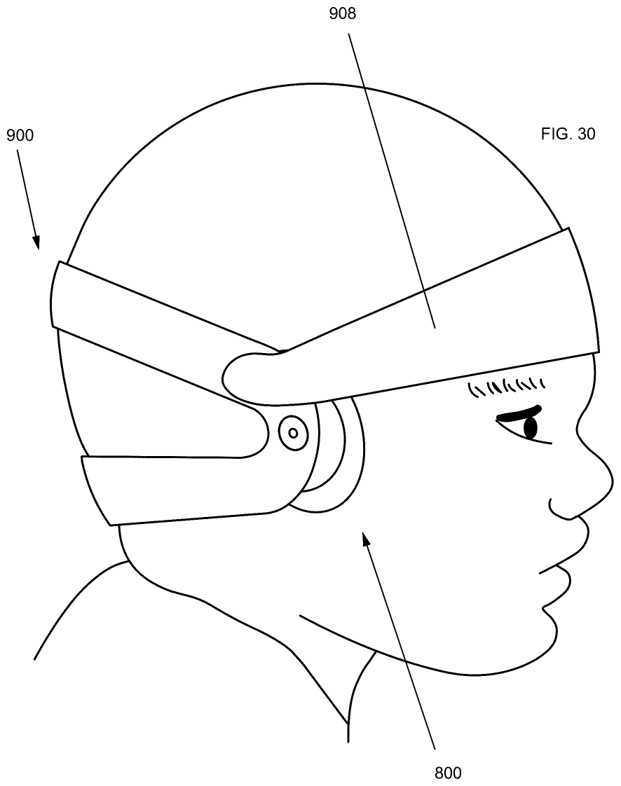

Referring to FIG. 30, which depicts an infant wearing the embodiment of the headband 900 shown in FIG. 29B with an attached forehead strap 908. The forehead strap 908 attaches to headband 900 slightly above the hole 922 on both sides. The forehead strap width is largest in the middle and slightly tappers to the ends where it attaches to the headband 900.

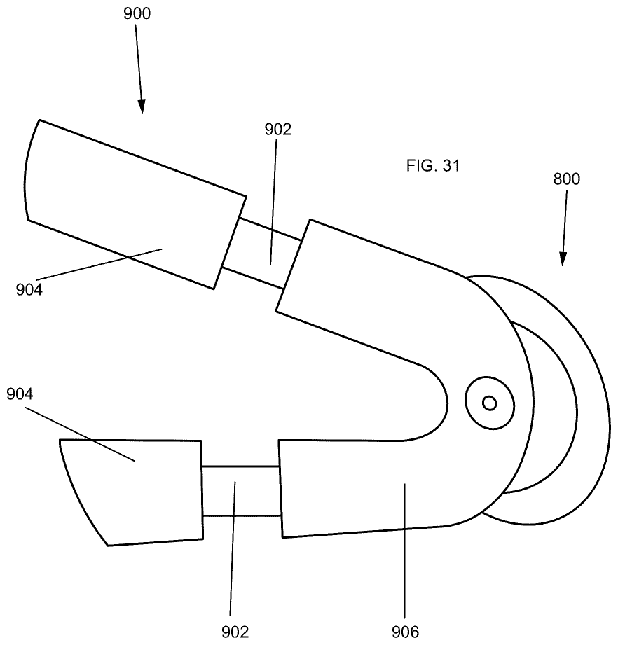

FIG. 31 depicts an adjustable forehead strap based off the embodiment shown in FIG. 28A. The headband 900 may include an inner support shaft 902 that allows for an extension between the first outer support 906 and the second outer support 904. This extension mechanism allows for the headband 900 to vary in length to accommodate different sizes of infant heads.

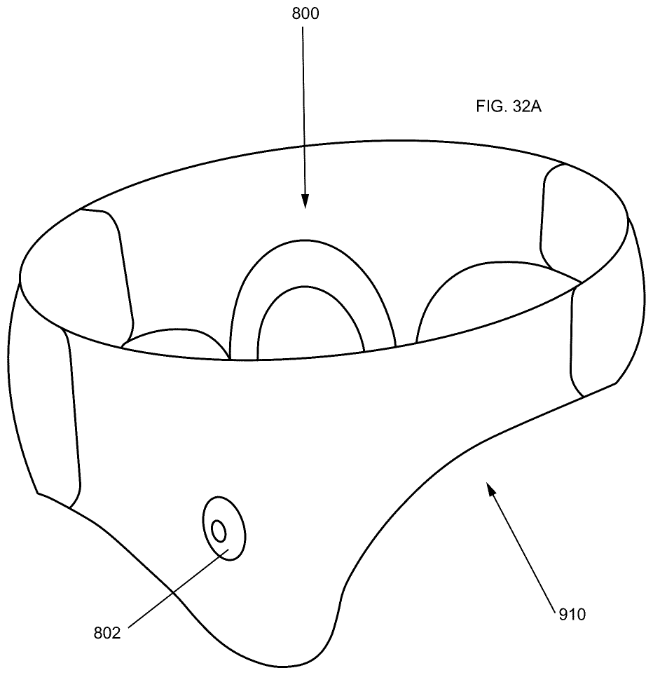

FIG. 32A depicts an of embodiment of a full circular headband 910.

Referring to FIG. 32B, which depicts an infant wearing the embodiment as shown in FIG. 32A.

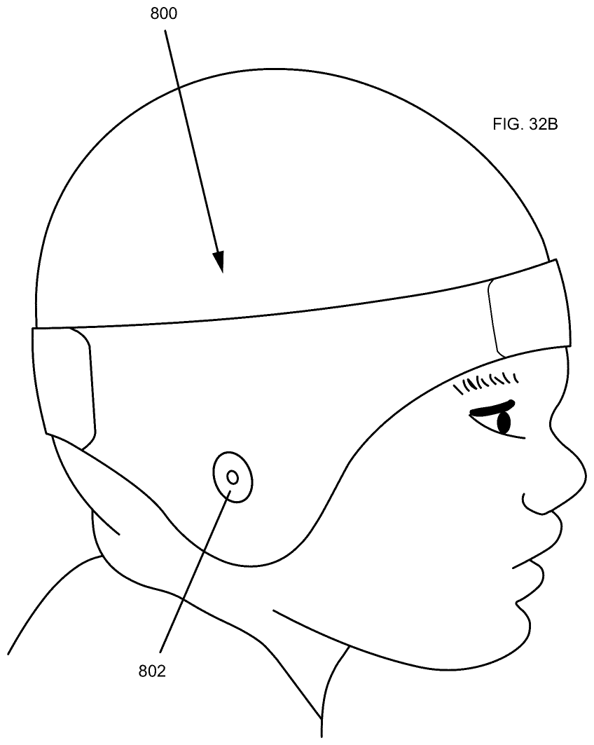

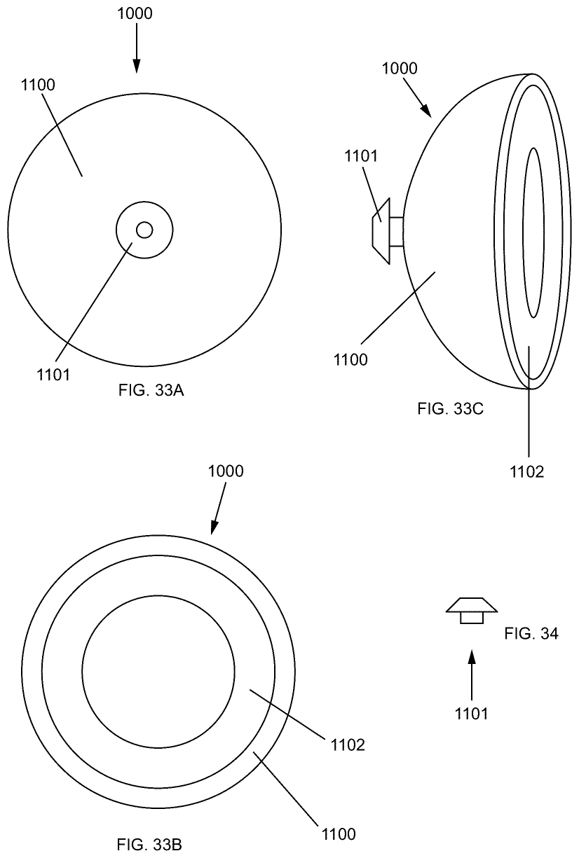

FIG. 33A depicts the top view of an earpiece assembly 1000 that may be detached from the headband 900 to be replaced with another earpiece 1000 that has the same attenuating properties or another earpiece 1000 that has higher or lower sound attenuating properties. This top view shows the button 1101 and outer attenuating material 1100.

FIG. 33B depicts the bottom of the earpiece assembly 1000. The outer layer of attenuated material is shown 1100 next to an inner layer of padding 1102.

FIG. 33C depicts a side view of the earpiece assembly 1000. The button 1101 attaches to the outer layer of attenuating material 1100, which gradually slopes down in a round shape to the bottom where it is flat. Inside the outer layer 1101 the padding 1102 may be attached as seen from the bottom view in FIG. 33B.

FIG. 34 depicts an embodiment of a button 1101.

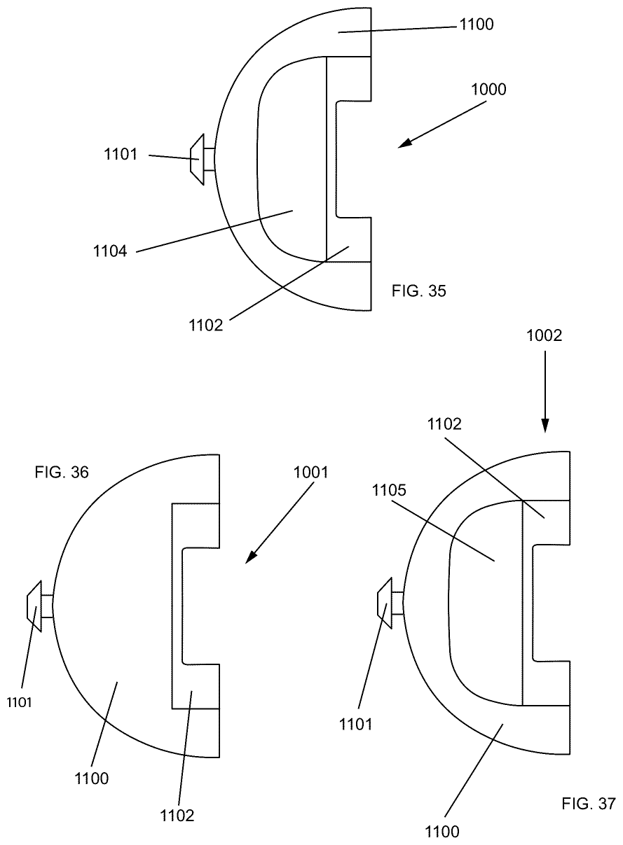

FIG. 35 shows a cross-section view of the earpiece 1000 shown in FIG. 33A where the outer attenuating layer 1100 is a different attenuating material from the inner attenuating layer 1104.

FIG. 36 shows a cross-section view of another embodiment of the earpiece 1000 shown in FIG. 35 where the outer attenuating layer 1100 is the primary attenuating material. The padding member 1102 may also help attenuating sound and may be coupled to the outer attenuating layer 1100 and made of a different material than the outer attenuating layer 1100.

FIG. 37 is another cross-section view of an embodiment of the earpiece 1000 shown in FIG. 35 with an outer attenuating material 1100 and an inner attenuating material 1105 which may be a composite of materials 1100 and 1104 shown in FIG. 35.

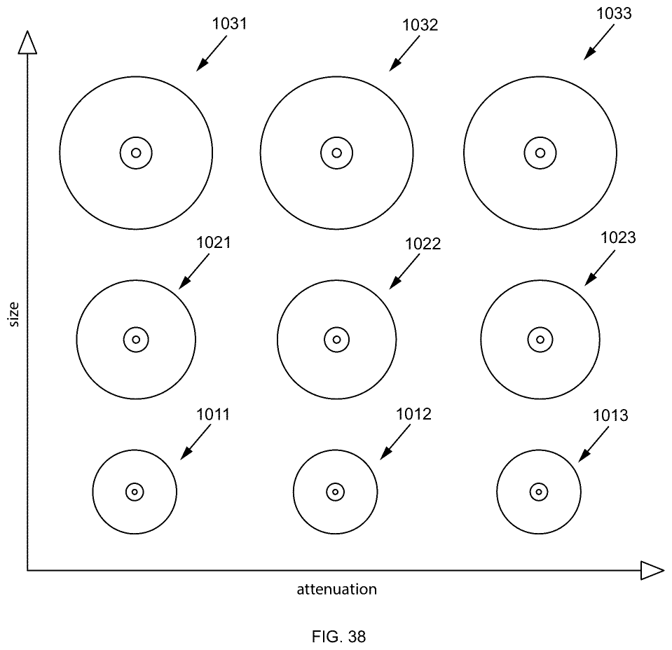

FIG. 38 depicts earpieces with different sizes and materials and how size and material may affect attenuation: 1011 represents an earpiece with small size and low attenuation; 1021 represents an earpiece with medium size and low attenuation; 1031 represents an earpiece with large size and low attenuation; 1012 represents an earpiece with small size and medium attenuation; 1022 represents an earpiece with medium size and medium attenuation; 1032 represents an earpiece with large size and medium attenuation; 1013 represents an earpiece with small size and high attenuation; 1023 represents an earpiece with medium size and high attenuation; and 1033 represents an earpiece with large size and high attenuation.

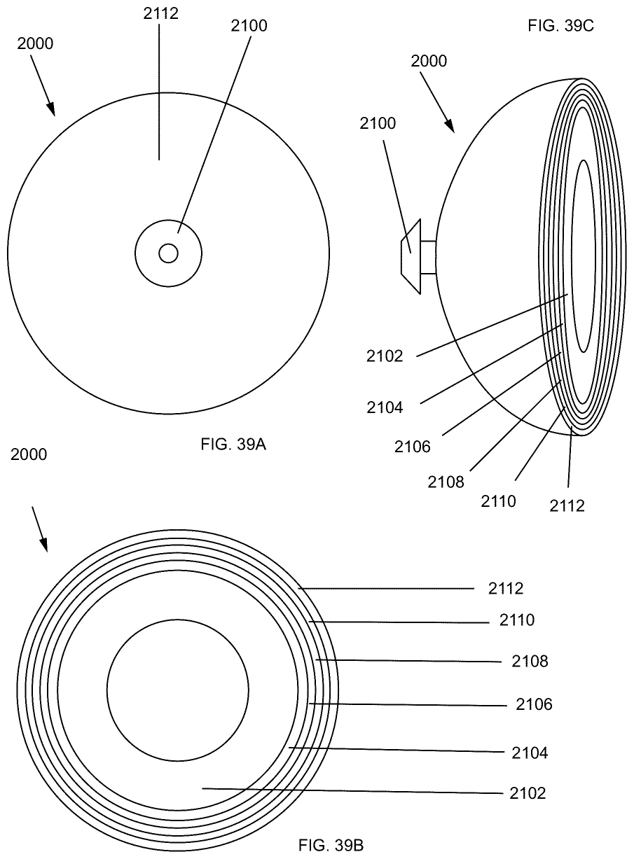

FIG. 39A depicts another embodiment of an earpiece with a plurality of peelable layers 2000. 2112 represents the fifth or outermost attenuating layer of the earpiece. 2100 represent a button that attaches to the headband 900.

FIG. 39B depicts the bottom view of earpiece 2000. 2102 represents a padding layer. Each of the following embodiments may represent a separate attenuating layer: 2104 the first and innermost layer that may be next to padding 2102; 2106 may be the second attenuating layer; 2108 may be a third attenuating layer; 2110 may be a fourth attenuating layer; and 2112 may be a fifth attenuating layer. There may be more or less than 5 layers.

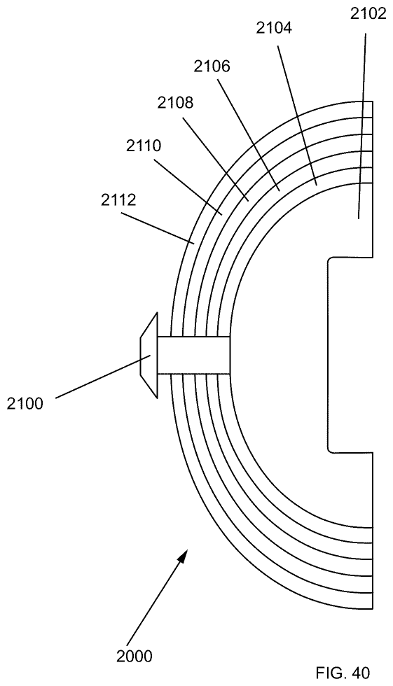

FIG. 39C depicts a perspective view of FIG. 39A. The button 2100 may be in the center of the earpiece with the attenuating material represented by 2112, 2110, 2108, 2106, and 2104 sloping or rounding down from the button 2100. The sloping or rounding may stop and may be flat with padding material 2102 inside. FIG. 40 depicts a cross section view of 2000, FIG. 39A. The button 2100 may be permanently coupled to the padding member and may be detachably coupled to each of the attenuating layers, which may be temporary. All of the ear pieces 2000 may have the innermost attenuating layer 2104, but may have a variable number of layers between the innermost attenuating layer 2104 and the outermost attenuating layer 2112. To achieve a lower attenuating amount for the ear piece 2000, layers (2104, 2106, 2108, 2110, 2112) are removed until the desired attenuating amount is reached. The maximum attenuating amount may be achieved by having the maximum number of layers. The minimum attenuating amount may be achieved by having only the innermost layer. The layers may be attached together using an adhesive, friction, magnets, or other binding means.

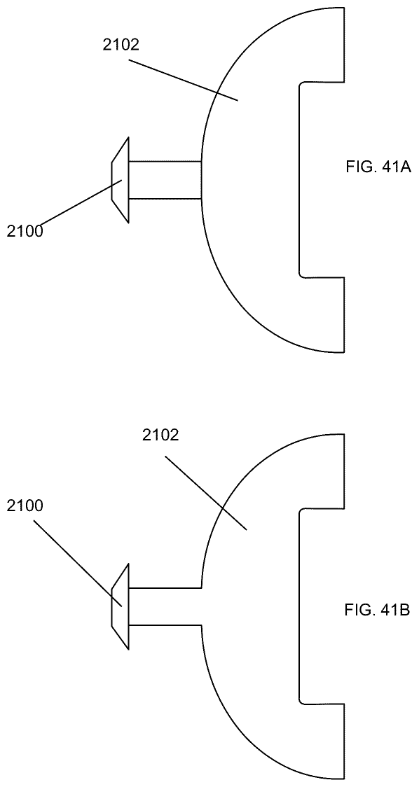

FIG. 41A depicts the padding member 2102 and the button 2100 which may be permanently attached to each other.

FIG. 41B depicts an alternative design where the button 2100 and the padding member 2102 may be the same piece.

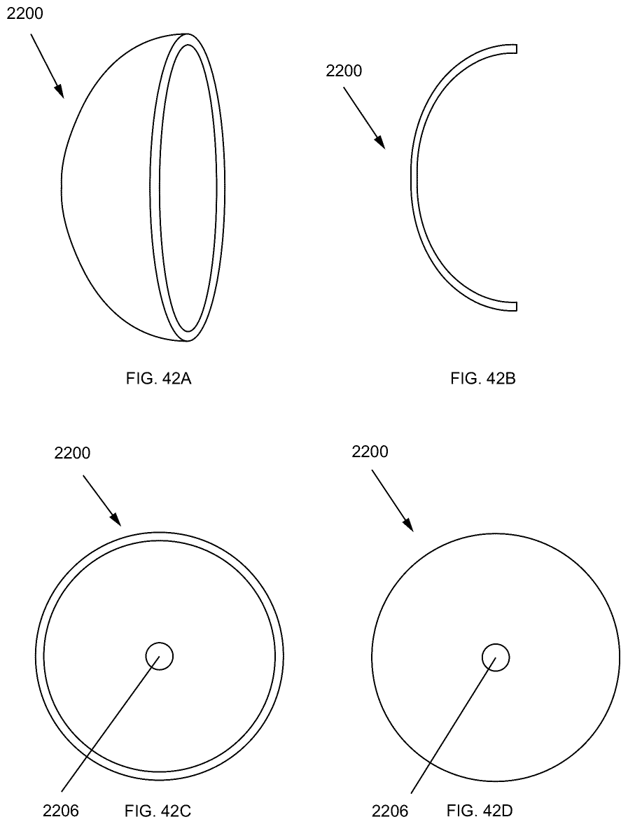

FIG. 42A depicts one of the attenuating layers (2104, 2106, 2108, 2110, or 2112) depicted in FIG. 40. This embodiment of the attenuating layer 2200 is made up of one type of attenuating material, usually silicone.

FIG. 42B depicts a cross-section view of FIG. 42A and shows the attenuating material 2200 may be the same thickness throughout.

FIG. 42C depicts a bottom view of FIG. 42A. 2206 depicts that the 2200 attenuating layer may have a hole that may be used to fit a button 2100 through. The 2206 hole may be in the center of the attenuating layer.

FIG. 42D depicts a top view of FIG. 42A with the hole 2206 that may be in the center of the top.

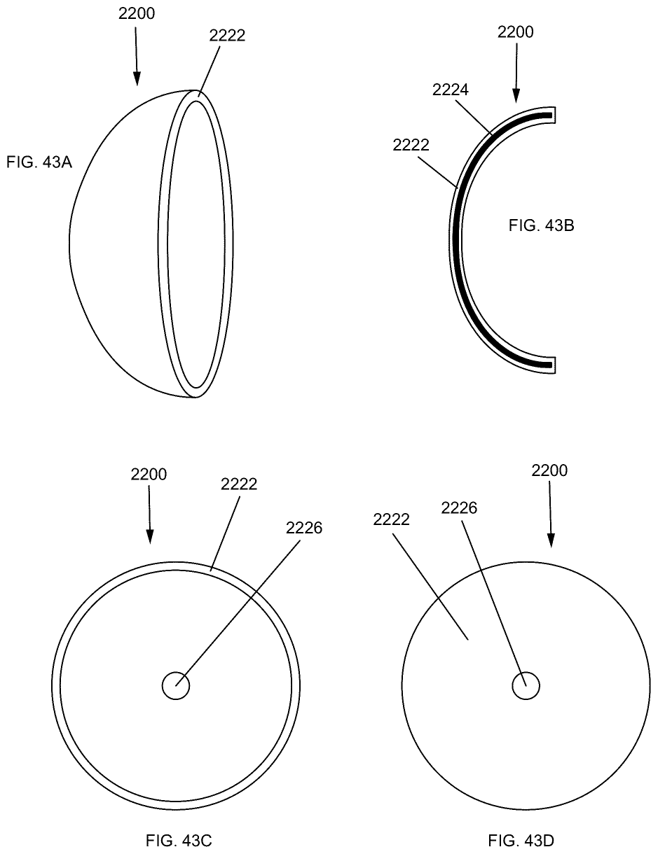

FIG. 43A depicts another embodiment of the attenuating layers (2104, 2106, 2108, 2110, or 2112) depicted in FIG. 40. This embodiment of the attennuating layer may be a layer comprising two or more different materials with an outer attenuating layer 2222, and the inner material 2224 is embedded inside the outer attenuating layer 2222.

FIG. 43B depicts a cross section of FIG. 43A where 2224 is the inner attenuating material and 2222 is the outer attenuating material.

FIG. 43C depicts the bottom view of FIG. 43A. 2226 depicts a hold that may be used for a button that may be in the center of the outer attenuating material 2222.

FIG. 43D depicts the top view of FIG. 43A where the hole 2226 may be in the center of the outer attenuating material 2222.

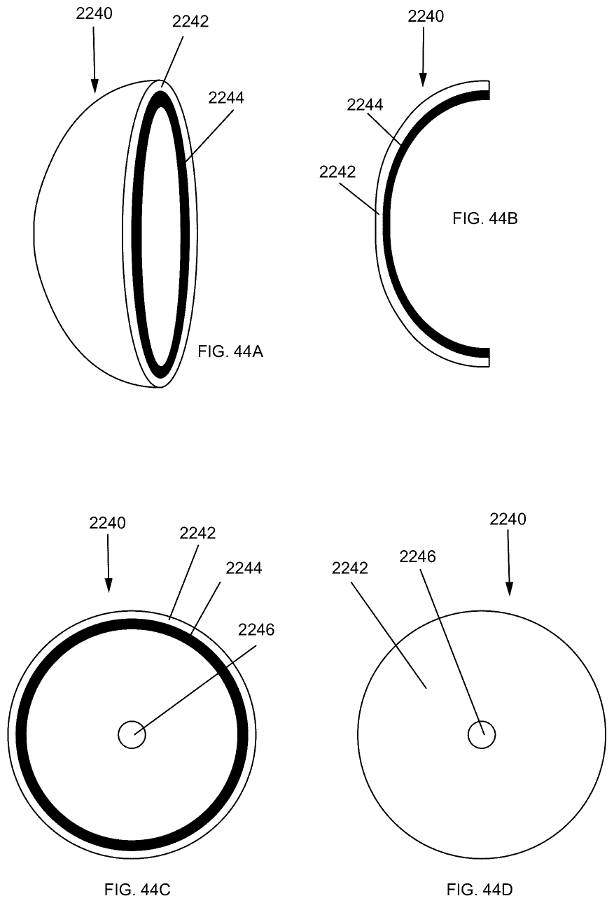

FIG. 44A depicts another embodiment of the attenuating layers used in the ear piece 2000. In this embodiment 2240, each layer may be composed of 2 sublayers. Each sublayer is a different attenuating material. For example, layer 2224 might be a compressible material and layer 2242 might be silicone.

FIG. 44B. depicts a cross section of this embodiment 2240 in FIG. 44A.

FIG. 44C depicts the bottom of the attenuating sublayers where 2242 and 2244 may be different materials. An element 2246 defining a hole that may be used for a button and may be in the center of the attenuating sublayers 2242 and 2244.

FIG. 44D depicts a top view of FIG. 44A where the hole 2246 may be in the center of the attenuating sublayers 2242 and 2244. Attentuating sublayer 2242 may be comprise material that is disposed in an outer location and is shown on top in this figure.

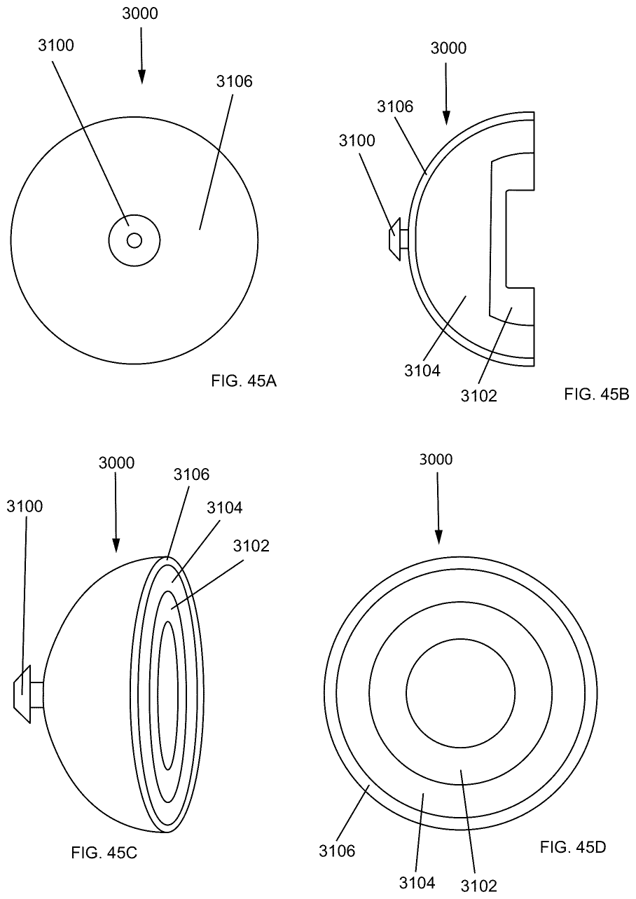

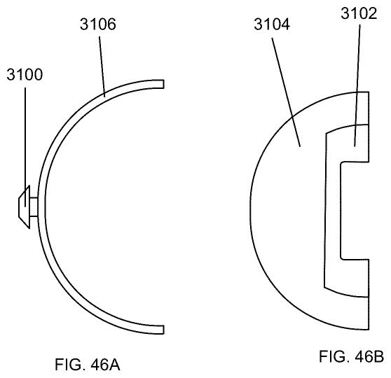

FIG. 45A depicts an embodiment of the earpiece where the outer attenuating layer is permanent and not replaced 3000. 3100 depicts a button that may be in the center of attenuating layer 3106, which may be used to attach the earpiece to the headband 900. 3106 depicts an outermost permanent attenuating layer.

FIG. 45B is a cross-section view of FIG. 45A. The outer layer may include the button 3100 and a permanent attenuating layer 3106. The inner layer may include inner attenuating material 3104, which may be different material than the outer attenuating material 3104, and padding 3102.

FIG. 45C depicts another view showing the same elements found in FIG. 41B.

FIG. 45D depicts a bottom view of the earpiece 3100 found in FIG. 45A.

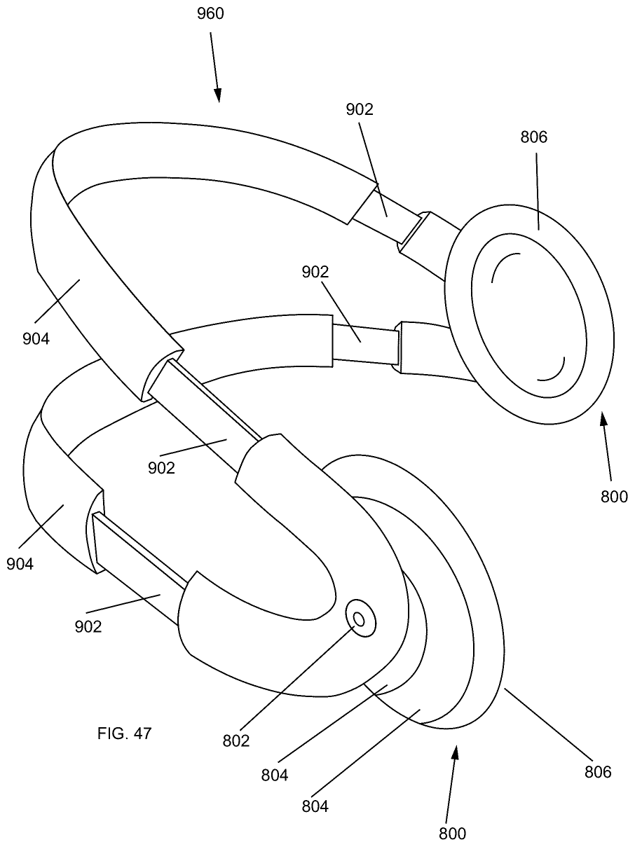

FIG. 46A depicts the outer layers of the earpiece 3000 depicted in FIG. 46A where there is a button 3100 and outer attenuating layer 3106.

FIG. 46B depicts the inner layers of the earpiece 3000 where 3104 represents inner attenuating material and 3102 represents padding.

Referring to FIG. 47, which depicts an embodiment of the headband with earpieces attached as shown in FIG. 29A, but are adjustable for size. The neonatal sound attenuation system of claim 4, wherein:
the first portion of the headpiece is extendably coupled to a third portion of the headpiece via a first slidable bar, wherein the third portion of the headpiece securely and slidably surrounds the first slidable bar having a compressible-expandable tip, wherein the third portion of the headpiece further comprises a first lip configured to frictionally prevent the compressible-expandable tip from moving beyond the first lip when a mature user pulls on the first portion of the headpiece without exertion, wherein the first portion of the headpiece is configured to securely position the first sound-attenuating earpiece against the first ear of the user; and,

The second portion of the headpiece is extendably coupled to a fourth portion of the headpiece via a second slidable bar, wherein the fourth portion of the headpiece securely and slidably surrounds the second slidable bar having a compressible-expandable tip, wherein the fourth portion of the headpiece further comprises a second lip configured to frictionally prevent the compressible-expandable tip from moving beyond the second lip when a mature user pulls on the second portion of the headpiece without exertion, wherein the second portion of the headpiece is configured to securely position the second sound-attenuating earpiece against the second ear of the user.

The auditory neural pathways develop gradually with the infant in the womb 19-27 weeks being able to respond to 500 Hz and attenuate sound below 500 Hz (it is contemplated that for this time period of gestational age (regardless of whether the infant has been born but calculated from the estimated date of gestation), a claimed device or method will be used to provide a high-level or maximum level of attenuation); an infant 33-40 weeks being able to respond to 1000 Hz and attenuate sound below 1000 Hz (it is contemplated that for this time period of gestational age (regardless of whether the infant has been born but calculated from the estimated date of gestation), an claimed device or method will be used to provide a medium level of attenuation); and an infant full term being able to respond to 400-4000 Hz and attenuate sounds below 4000 Hz (it is contemplated that for this time period of gestational age (regardless of whether the infant has been born but calculated from the estimated date of gestation), a claimed device and method will be used to provide a low-level of sound attenuation).

Any reference to a button may include a knob or handle. Padded member 108 may be made from a quilted wool/cotton blend, the stuffing of padded member 108 may be also made from a quilted wool/cotton blend; the stuffing of padded member 108 may be made of cotton, batting, a cotton-blend or some other compressible material including foam.

The foam may have one or more of the following properties: elasticity, porosity, thickness, and cell size.

Reclosable fasteners may be used; and the fastening patch 500 may be coupled by sewing or other means such that the fastening patch is not easily dislodged when an infant, who is wearing the headpiece 113 having the fastening patch, tosses and turns.

In some embodiments, materials used in the assembly or devices preferably lower sound levels between 20-30 dB. Materials that are used in the assembly or devices preferably dampen sound instead of deadening sound; in other words, materials preferably attenuate sound instead of completely canceling sound or noise. Some materials which may be incorporated in the assembly or device maybe medical grade materials. In the preferred embodiments, materials which are used in the assembly or device are not overly rigid and have some degree of flexibility.

In the preferred embodiments, headpiece 113 and the sound attenuating assembly may be configured to be compatible with the use of medical devices such as tubes and CPAP oxygen machines. The use or disclose invention is not limited to prematurely born infants and different embodiments of the invention may be used with infants, prematurely born infants, children, adolescents, adults, senior citizens and disabled people, and consequently, the sound attenuating assembly 100 and its components may be of various sizes and shapes. Premature babies may vary greatly in size, weight, and head circumference. In preferred embodiments a baby or individual may lay on top of the sound attenuating assembly and its components without being damaged. In the preferred embodiments the components of the sounds in the assembly 100 are not substantially bulky. In the preferred embodiments, the headpiece is configured to fit snuggly with an individual such as a baby. In the preferred embodiments the headpiece is not configured to fit so tightly that the user experiences great discomfort or has decreased blood flow areas in the areas that are contacted by the headpiece.

In some embodiments, the headpiece may be of a size that fits a premature baby of various sizes or an individual regardless of the individuals age or size.

In the preferred embodiments, the dampening assembly, which is the portion that may attenuate sound, may be sized to cover an entire ear of an individual. Preferably, two dampening assembly may be used so that each ear may be covered. Preferably headpiece 113 does not cover the eyes or nose of an individual or prematurely born infant. Preferably nurses or other caretakers may remove headpiece 113 and its component with substantial ease. Preferably headpiece 113 and its component do not interfere, or only minimally interfere, with medical devices that may be in use with a prematurely born infant who may be using IVs, feeding tubes, bilirubin glasses, oxygen, ventilator, nasal canula, CPAP, head sensors, incisions, etc.

Any listed measurements are only exemplary; preferable ranges may fall within −10% and +10% of the stated measurement values; preferable ranges fall may within −30% and +30% of the stated measurement values; some ranges fall may within −50% and +50% of the stated measurement values; some ranges fall may within −90% and +1000% of the stated measurement values.

The following components may be included individually or in combination with other components which are listed herein; details are exemplary and nonlimiting.

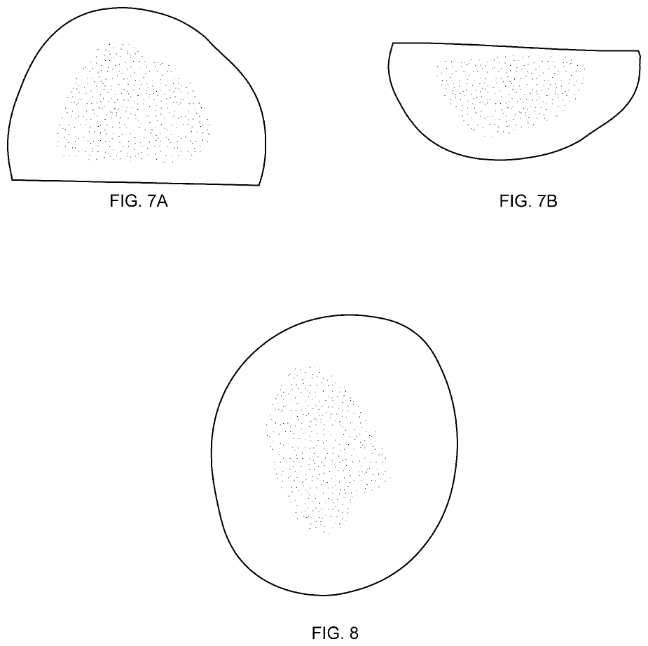

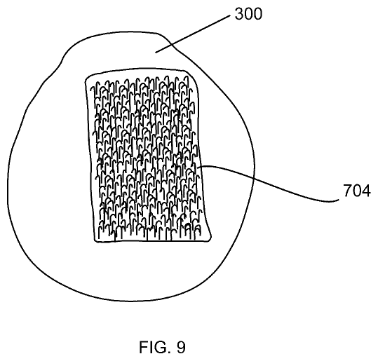

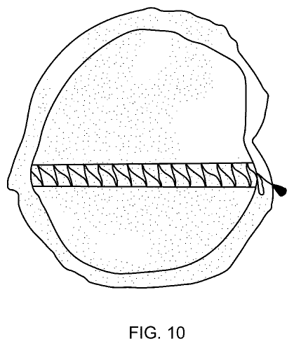

Referring to FIGS. 7A, 7B, and 8, the first front cover of FIG. 7A may be coupled to the back cover so as to form a pocket, and the second front cover of FIG. 7B may be coupled to the back cover so as to form a pocket overlapping with a portion of the first front cover and being above the first front cover; vice-versa scenarios are also contemplated by this disclosure such that the first front cover is overlapping with a portion of the second front cover and also is disposed above the second front cover.

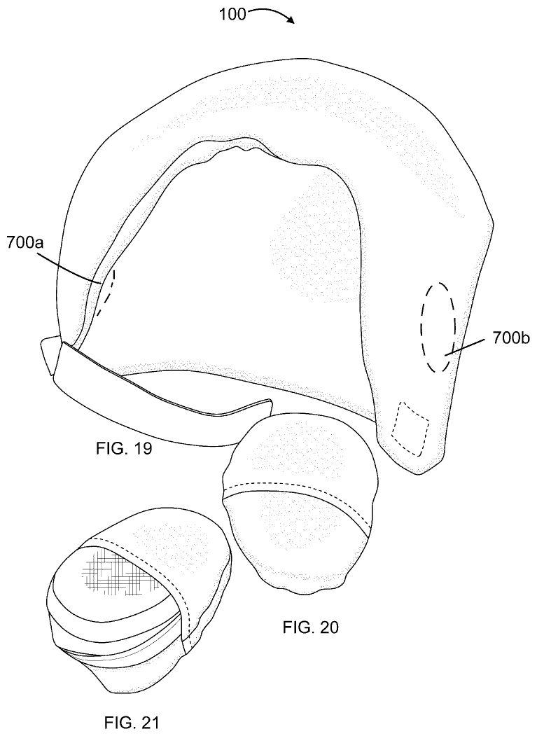

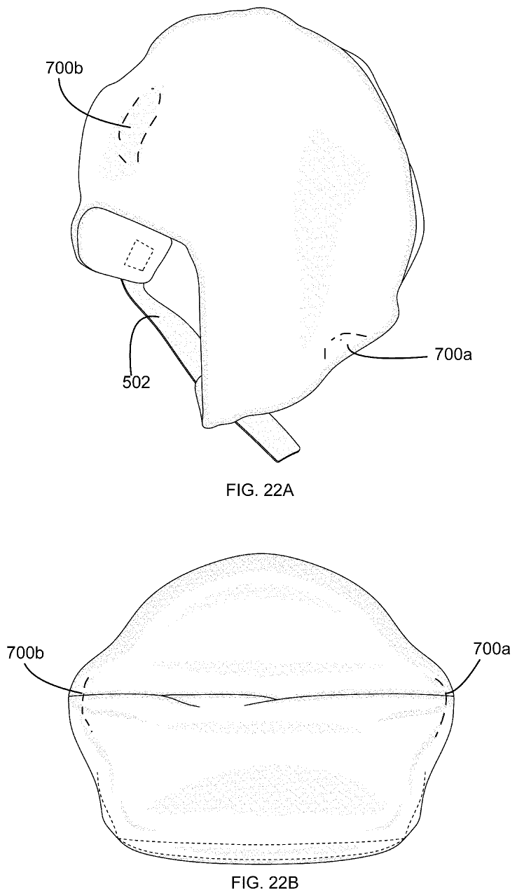

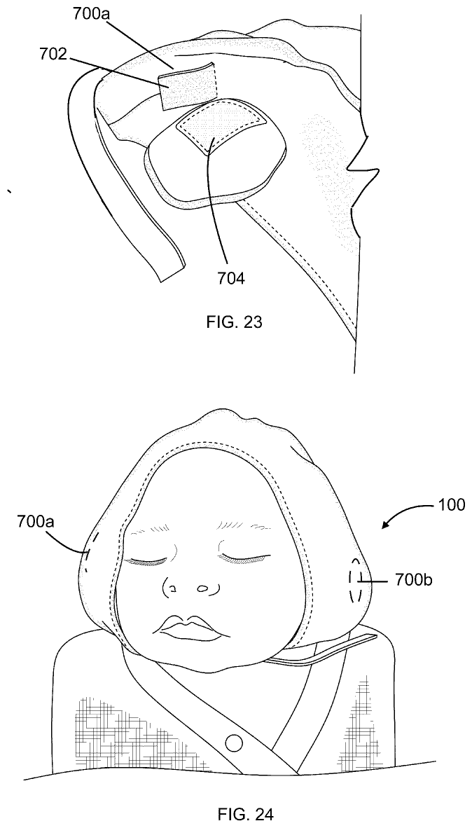

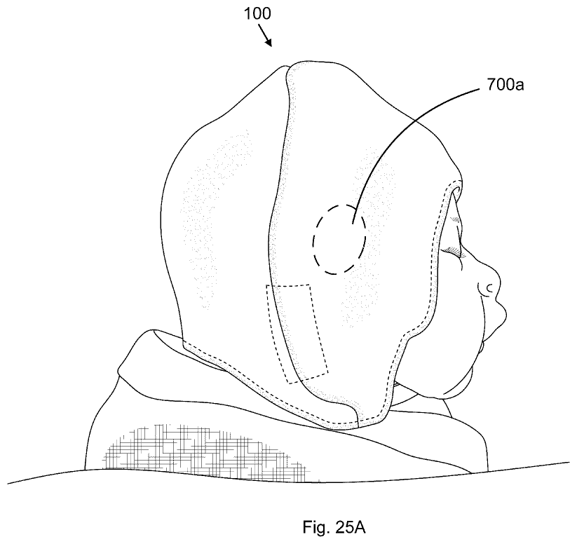

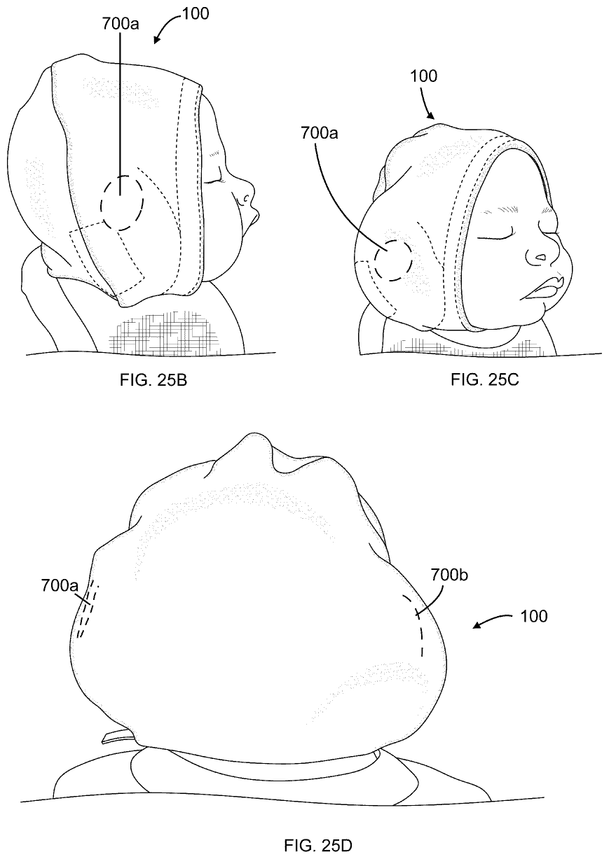

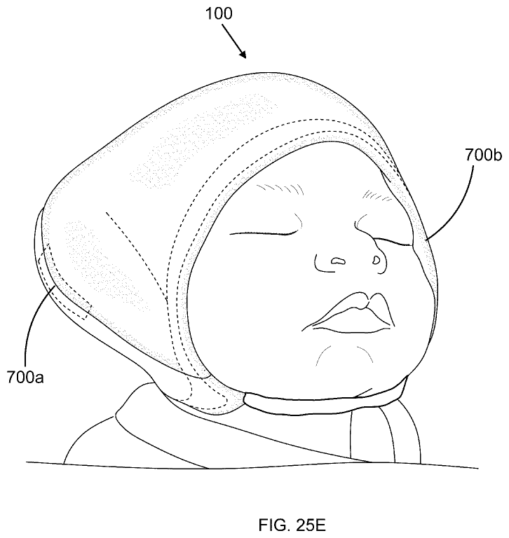

FIGS. 19, 20, and 21 depict an embodiment of a sound attenuating assembly 100. headpiece 113 may have one or more pockets (713a, 713b) or may have a fastener patch, such as a hook-and-loop patch that may attach to a dampening assembly's corresponding fastener patch or a covered dampening assembly's corresponding fastener patch.

Any component with the word “member”, such as concave member 102 or compressible member 104, may be of any shape; in the preferred embodiments, may be circular, oval, squarish, rectangular, ear-shaped, or elliptical,

Sound attenuating assembly 100 may include a dampening assembly that may include a concave member 102, which may be large enough for other components to be disposed within concave member 102; a compressible member 104, a dividing member 106 (which is not present in some embodiments); a padded member 108

Compressible member 104 may be made of foam or other compressible material.

Dividing member 106 may be made of card stock;

A padded member 108 may be included;

headpiece 113 may cover the ears, at least some of the neck and at least some of the head of a wearer;

A cover 300 may be made from cloth or some other material.

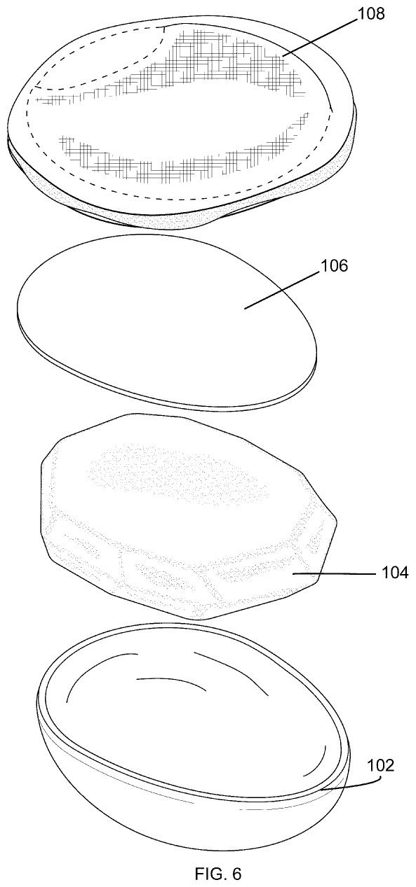

An embodiment of dampening assembly 400 is shown in FIG. 5B.

4 pieces may be used to make the headpiece 113; 3 pieces may be used to make the pocket. Dampening assembly and covered dampening assembly may reduce sound levels between 10 and 100 db with a target reduction of 30-50 db.

Cardstock may be the 140 lb type; height of dividing member 106 may be 3.2 cm and the width of dividing member 106 may be 3 cm.

concave member 102 may be a silicone egg mold or any other concave object that is large enough to engulf or partially engulf compressible member 104. The width of concave member 102 may be 4.2 cm; the length of concave member 102 may be 4.2 cm. The thickness of concave member 102 may be between 0.1 mm and 100 mm.

The length by width dimensions of padded member 108 may be 4.5 cm by 4 cm.

Foam may be used as the main material of the compressible member 104; in some embodiments the length by width dimensions of the compressible member 104 may be 3.9 cm by 3.4 cm and may be 1.5 cm in thickness.

Upper circumference of headpiece 113 may be 18.1 cm. headpiece 113 may have an upper central horizontal width of 11.4 cm; bottom horizontal width may be 14 cm; a band of material with a fastener on one end that may attach detachably to a fastener of the head piece may be coupled to an opposing side of the headpiece to form a chinstrap 502.

Cover 300 may be 4.5 cm by 5.2 cm.

Width circumference of cover 300 may be 12 cm.

Height circumference of cover may be 13 cm.

Sound attenuating assembly 100 may have removeable and adjustable earpieces to ensure proper fit. It may also have an adjustable chin strap to ensure that the sound attenuating assembly is fitted snugly around a wearer so as to form a substantial seal around the ear.

Ear covering may be worn by babies/children/adults to decrease the noise level. It may work by having materials that attenuate sound placed over the ear and may include a headpiece 113; headpiece 113 may be a band or headband or it may be a head covering with a neck covering portion and one or more ear flaps.

Each part of the earpiece may serve a function of assist with serving a function of lowering sound levels, attenuating sound levels, or providing comfort to a user wearing the earpiece. Earpiece may include one or more materials to provide attenuation or comfort. The design may include various materials such as a silicone convex ear piece, viscoelastic foam, cardstock, wool or cotton organic material blend. The neonatal sound attenuating system may include at least one pocket for receiving and storing earpiece materials. The pocket may contain hook and loop fastener for adjustment of ear piece placement. The pocket may detach and be adjusted for proper fit around the ear. Materials may also be removed from pocket for washing of pocket. An earpiece may be on each side of a neonatal sound attenuating assembly for placement over each ear. A headpiece may provide comfortable fit around the head and may include a hook and loop fastener strip to attach the earpiece. The headpiece 113 may also contain a strap, which may be hook and latch, to ensure proper fit of the earpieces over the ear. The headpiece 113 may also include designer elements such as bows. The earpieces and head piece may be sized to fit various head sizes.

The ear piece and its materials may contribute sound attenuation and comfort.

The headpiece and its parts may act to hold the ear piece in its proper place to ensure proper attenuation over the ears.

The headpiece may be used as a headpiece 113 for warmth or style, yet also may serve to support the earpieces.

The materials in the earpiece work to attenuate sound and may be comfortable.

The headpiece may hold the earpieces in place over the ears and may provide a surface for allowing for the adjustment of earpieces.

At least a portion of the sound attenuating materials may be preferably placed over the ear to attenuate, decrease, or lower the sound level. Headpiece 113 may have a strap or other member for holding a dampening assembly or covered dampening assembly in its proper place. The upper portion of the head piece may be substantially elevated so as to not cover or obstruct the eyes or nose. The head piece may also provide sufficient fit and covering to properly hold/support the earpieces in their proper placement over the ears.

The earpiece may be of various shapes, and the earpiece may be configured to receive and engulf, or at least partially engulf at least one neonatal ear; in some embodiments, the earpiece may be configured to be disposed near at least one ear of a neonatal user so as to transmit sounds via bone conduction. The earpiece may include materials that are known to have sound attenuating properties.

Various designs and patterns may be used for the head piece; in the preferred embodiments, the head piece may use a fastener with detachable-attachable properties, such as a hook loop fastener or other type of adhesive or detachably adhesive material that may be located in the area of the headpiece that would touch or be facing a wearers ear; and a patch with a fastener may also be coupled to that location so that a covered dampening assembly with a fastener 704 on the outer surface (or a dampening assembly without a cover that has a fastener on the outer surface of the concave member 102) may then be adjustably coupled to the patch such that the covered dampening assembly may be coupled with the head piece 13 or held in place against the head piece; the location 700 at which such a patch 702 for coupling the covered dampening assembly 400 to the head piece is shown in the figures; the shape of the patch 702 may be rectangular, elliptical, or some other shape. A patch 702 may be coupled to one side of the headpiece 113 and a second patch may be coupled to an opposing side of the headpiece 113 since most individuals have two ears and would usually benefit from having a dampening assembly 400 or covered-dampening assembly 200 attached to the patch 702 and a second dampening assembly 400 or a second covered-dampening assembly 200 also being attached to a second patch. In the preferred embodiments an adhesive or detachably adhesive material is located on the outer surface of the ear piece and substantially couples with a support strip that is made of a material that allows for the adhesive or detachably adhesive material of the outer surface of the ear piece to attach of detachably attach to the support strip. The support strip may be coupled to the inner surface of the device.

Listed materials are nonlimiting. The parts in the ear piece, also known as a dampening assembly or covered dampening assembly, may be of a type of material that is not explicitly listed in this patent application. If another material or combination of materials is found to provide similar attenuation and comfort. The ear piece cannot be eliminated. The design and pattern of the head piece could change as long as it provides support for the earpieces. The cover may have a back portion and two front portions; the two front portions may overlap but also may be open such that a dampening assembly may be slid into an inner cavity of the cover and be substantially engulfed by the combination of the back portion of the cover and the two front portions; a zipper may be used or a fastener may be used such as a button or hook-loop fastener system having a first hook loop fastener opposed to a mateable second hook loop fastener to reclosably close the opening of the cover.

Embodiments may include bone conduction piece that would play sounds similar to what may be heard in the womb including mother's voice, heartbeat, and other ambient sounds. Bone conduction is the way a fetus hears sound in utero. It may also include the use of developmentally appropriate sounds to improve auditory development.

Any of the members or layers may be removed. It is possible the cardstock could be left out of the ear piece as it may lose its support integrity over time and use.

The product could be used on babies outside of the NICU or hospital setting or full-term babies. It could also be used for small children, children, adults or anyone with a need for sound attenuation from loud environments. The product may be sized for various head sizes. The earpieces may be worn over the ears and may be held in place as to stay over the ear continuously.

The earpieces may be made with materials that attenuate sound and are feasible and comfortable in the wear of the product. The head piece may be made of material that is soft and flexible for ease and comfort in wearing.

Wearing the ear piece over the ears and being held in place to create proper fit is preferred. Cotton may be used for the headpiece 113; concave member 102 may be made of silicone and some embodiments a silicone mold such as a Wilton silicone egg mold may be used for concave member 102.

Some embodiments consist of two main portions: the earpiece and the headpiece. The earpiece is configured for sound attenuation, and the headpiece holds the earpieces in place. Below are descriptions of the earpiece and headpiece embodiments.

As disclosed in applicant's previous applications, positioning of earpieces and increased effectiveness of earpiece are desirable. The present application discloses an earpiece embodiment that reduces sliding movements or movements of the earpiece or the headpiece; an embodiment is disclosed that goes around the outside of the ear to provide a concave shape around the ear and also to create space around the ear, which puts little to no pressure on the ear.

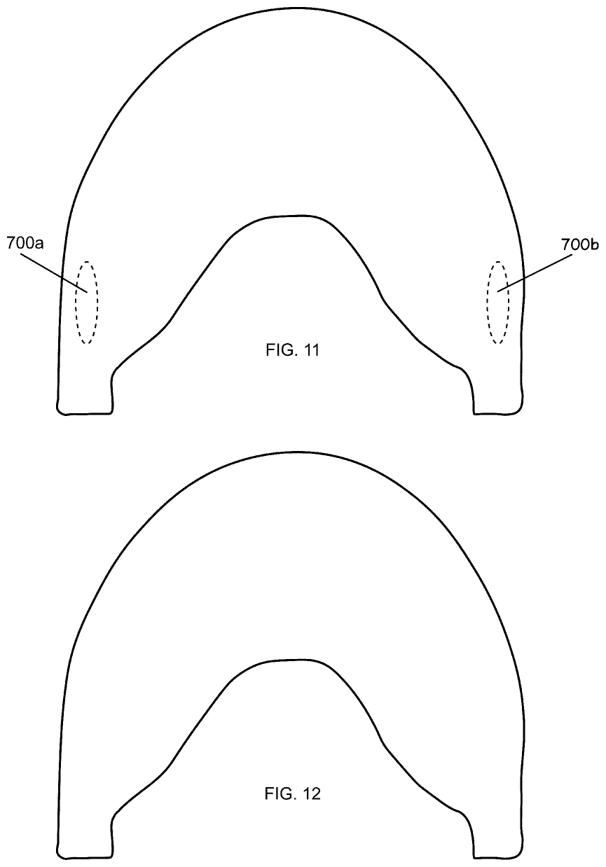

The material of the earpiece may consist of the original outer silicone layer (FIG. 11b), followed by a layer of viscoelastic foam (FIG. 11c). Both materials may provide sound attenuation. The earpiece may consist of an exterior sound attenuating shell (silicone material) (FIG. 11b), the inner sound attenuating layer (viscoelastic foam material) (FIG. 11c), and padded oval-ring shaped ear cushions that are configured to be pressed around the ear on the skull (foam material) (FIG. 11c). The additional two layers of cardstock or wool-cotton blend material may be eliminated in some embodiments. By using silicone and foam materials, the layers may be molded and blown into one piece in the manufacturing process (FIG. 11a), which will allow for ease in manufacturing and assembly. Another benefit includes being more easily cleaned by surface wiping the earpiece rather than disassembly and washing of material. This allows for increased sanitation in the hospital setting. The original level of sound attenuation that consisted within the original 4 materials can be achieved through increasing the thickness of the silicone layer and foam and by creating a light seal around the ear with the improved embodiment. The thickness of the silicone outer layer may be between 1-3 ml thick. The thickness of the foam layer may be less than 2 cm in thickness or the density of the material will be increased.

A plurality of sizes of the earpiece may be manufactured and used depending on the size and growth of the infant.

### The Exterior Shell

The exterior shell may be composed of silicone that is pliable for comfort and flexibility. The silicone material provides both structure to the earpiece and sound attenuation. The thickness of the silicone outer layer may be between 1-3 ml thick.

From the top (FIG. 11d) and side view (FIG. 11a), the shape of the earpiece may be a round shape, such as an oval shape, as disclosed herein. The shape of the earpiece may extend diagonally to define a conal shape or generally conal shape from the outer edge of the oval ring and the edge may be configured to have a more flattened shape to allow for proper attachment of the button, which exists to attach to the headpiece.

From the bottom view (FIG. 11E), it may be an oval and concave shape that may circle around the outside of the entire ear and cups around the ear. The exterior back of the outer shell may flatten. The exterior back of the earpiece embodiment may also include a button that may be a small, soft, flexible button that may be attachable to the headpiece and may allow for adjustment on the headpiece. The button may allow for pivotal adjustment on the earpiece at a plurality of degrees depending on the shape and placement of the ear. The button may consist of the same silicone material used on the outer shell of the earpiece and may be attached via a mold in the manufacturing process (FIG. 11b). The button may have a stem that may be less than 0.5 centimeters in height and 0.5 centimeters in width. The stem may attach to the upper button which may help hold the earpiece in place so as to not pop out of location on the headpiece. The upper button portion may be less than 1 centimeter diameter and less than 0.5 centimeters height. It may also have a flat or dome shape.

### Inner Sound Attenuating Layer

The inner layer may be composed of a sound attenuating foam (such as viscoelastic or antimicrobial polyurethane), additional silicone, or flexible plastic, or combination of materials to provide sound attenuation and comfort around the ear (FIG. 11c). The inner layer of the earpiece may be adhered to the exterior silicone shell via manufacturing. The shape may be concave as to allow room for the ear to fill the space when it is placed on/around the ear. The thickness of the foam layer may be less than 2 cm in thickness or the density of the material will be increased. The foam material may be placed in some embodiment as a separate piece that required assembly and may be placed in other embodiments as a single piece. By adhering the outer silicone layer and inner foam layer, it creates an ease in manufacturing, ease of cleaning and sanitation, and improved function.

### Outer Ring

The oval ring of the earpiece will extend around the outside of the ear to create a ring around the ear (FIG. 11c). The material may consist of a soft foam for comfort and flexibility allowing the placement to follow the curvature of the skull. The ring may function to create light gentle pressure so as to not create any excessive pressure on the soft skull bones around the ear. The oval ring will include a rounded cushion to decrease any pressure points and evenly distribute the light pressure around the ear. The light seal also creates sound attenuation by decreasing the amount of sound that gets through the earpiece which thus increases the effectiveness of the sound attenuation creating a sound level more appropriate for the infant. The ring may also function to hold the earpiece in place over the ear to prevent movement and sliding of the earpiece. The thickness of the ring may be approximately 1 cm thick and less than 1 cm wide.

### Sound Level Sensor

An audio sensor may be included in the earpiece that allows for data tracking of the infant's dB level exposure. The sensor may be placed inside the concave earpiece to measure the sound level the infant is exposed. The concave shape of the earpiece allows for placement of the sensor within the earpiece without touching or pressuring the ear. The data tracking allows for increased awareness of environmental sound levels and the effectiveness of the earpiece in attenuating the sound to acceptable developmental levels. The sensor may include a microphone on the inside of the earpiece to capture the sound level and a sensor or probe device that is exposed to the outside of the earpiece to capture the environmental sound level. Through wireless, wireless-technology for proximate or distant communication, or other connection technology, data may be tracked to improve the auditory environment and outcome of the infant.

### Original Earpiece

The original earpiece may be changed to have a silicone button molded to the exterior back of the silicone outer layer (FIG. 12a). The button may be used for attachment to the headpiece. The button allows for pivotal adjustment on the earpiece at a plurality of degrees to accommodate the placement of the ear and ensure proper placement of the earpiece over the ear. The button may consist of the same silicone material used on the outer silicone layer of the earpiece and will be attached via a mold in the manufacturing process (FIG. 12b). The button may have a stem that may be less than 0.5 centimeters in height and 0.5 centimeters in width. The stem may attach to the upper button which will help hold the earpiece in place so as to not pop out of location on the headpiece. The upper button portion may be less than 1 centimeter diameter and less than 0.5 centimeters height. It may also have a flat or dome shape. The outer material cover of the earpiece will have an elastic hole allowing for the silicone button to pop through for attachment to the headpiece.

### Headpiece

Upon testing the original headpiece (cap style embodiment) on premature babies in a neonatal intensive care unit, additional embodiment options were developed to overcome the constraints of the cap embodiment. There may be a plurality of headpiece embodiments needed to meet the needs of the infant depending on size, ability to maintain temperature, medical equipment in use, and oxygen needs (nasal cannula, Continuous Positive Airway Pressure machines, ventilator, etc.). Because different equipment, particularly oxygen equipment, requires various levels of access to the forehead and top of head area, cap wearing may be challenging in certain situations. Also, the goal is to have the infant maintain body heat on its own, so cap wearing for long periods of time is discouraged in some NICU settings. A plurality of headpieces may need to be utilized depending on the many factors of the infant including, but not limited to size of head and ears, ability to maintain temperature, medical equipment in use, and oxygen needs (nasal cannula, cpap, ventilator, etc.). For this reason, a plurality of headpiece embodiments have been developed to meet the medical needs of the infant.

### Behind-the-Head Headpiece

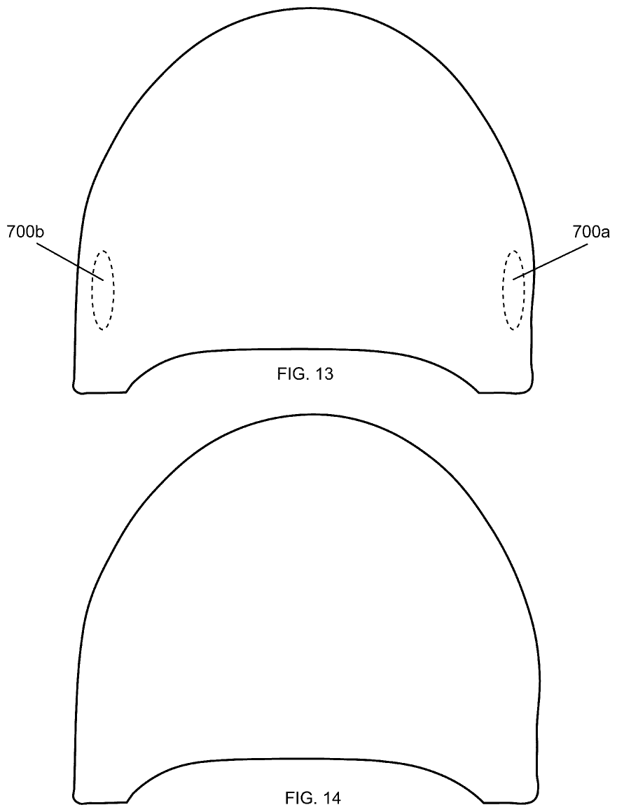

One of the alternative headpiece embodiments utilizes the back of the head with a behind-the-head headband. It may form a semi-circular shape on the back of the head that attaches to the outer side of each earpiece via a silicone button on the earpiece (FIG. 13a). The headband includes an upper band and lower band that join together with a curved U-shape where the earpieces attach (FIG. 13a). From the U-shape, the upper and lower band diverge at approximately 30 degrees and wrap around and cradle the back side of the head, creating light pressure, which acts to keep the earpieces in place (FIG. 13b). The middle portion, between the upper and lower band, may comprise a breathable mesh elastic fabric or other breathable material for structure (FIG. 13a & b). The upper and lower band of the behind-the-head embodiment increase the support to keep the earpieces in place without interfering with most medical equipment. The upper band may be disposed at the aforementioned angle to lay below the lower fontanel on the head as to not create any pressure on the soft spot. The headband embodiment also allows for evenly distributed pressure as to not create hot spots or excessive pressure on any one spot of the skull (FIG. 13b).

The upper and lower bands may adjust to allow for sizing to various head sizes and proper contouring to the head and to create light pressure to properly hold the earpieces against the head (FIG. 13c). The upper and lower bands may consist of a slide mechanism comprising an inner band (made of a flexible plastic or metal material) that is firmly encased in an outer sleeve (made of a flexible plastic or metal material). The outer band may firmly encase the inner band as to maintain the adjusted size and hold in place the inner band. The inner band slides into the outer band allowing for adjustability for different head sizes. The adjustability allows the bands to follow the curvature of the head and lay properly against the head for comfort. The outer sleeve may have a lip at the ends to stop the inner band from slipping out. The outer sleeve of both the upper and lower bands may be covered in a soft padded material such as neoprene to ensure comfort against the infant head. Adjustments may be made by lightly pulling on the headpiece near the earpiece for the slide adjustment to move.

Both earpiece embodiments (original and improved embodiment) may attach to the behind-the-head headband via the silicone button. A small hole in the neoprene fabric allows the button to slip through and be held snug. The button attachment may allow for the angle of the earpieces to be adjusted (FIG. 13a)

The headband may also consist of an additional strap that can attach to the side of the headpiece via latch or velcro and adjust toward the forehead for additional support if equipment allows (FIG. 13d). The strap may also consist of a neoprene material (or other soft cushioned material) that attaches to the outer sides of the earpieces and wraps around the forehead for added stability of the earpieces. In some situations, the strap may be removable and optional.

### Full Circular Headpiece

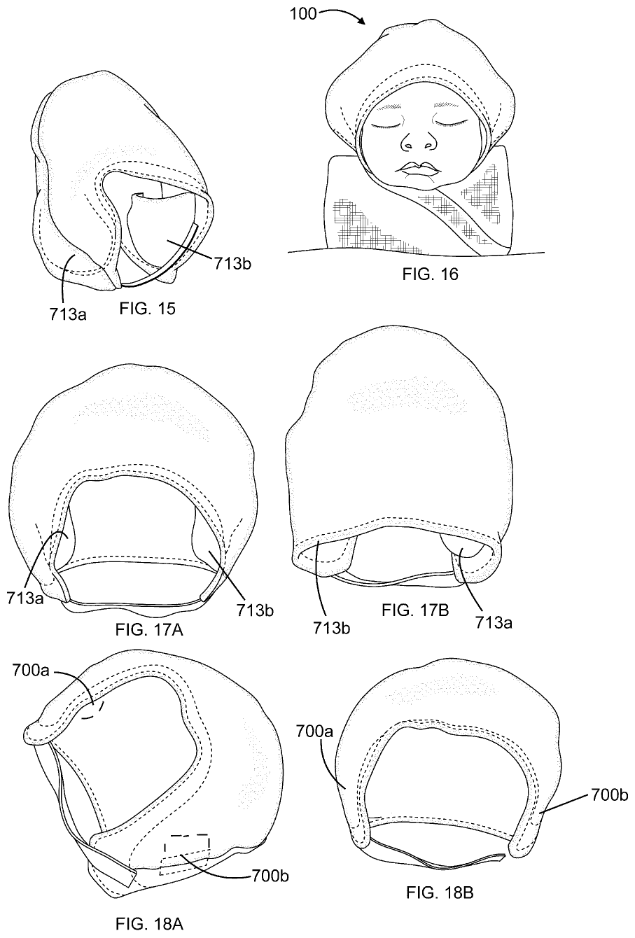

An additional headpiece embodiment may be a full circular headband that wraps around the back of the head and meets at the forehead with velcro straps for adjustability (FIG. 14b). The headband may also have velcro adjustability in the back for further sizing up or down if needed and for proper placement of the earpieces over the ears (FIG. 14b). The headband may be made of stretchable and cushioned material such as, but not limited to neoprene fabric. The headband may fully cover or partially cover a length of the forehead and may create light pressure over the earpieces to keep the earpieces from moving or sliding around (FIG. 14a). The headband may angle above the eyes to rest on the forehead for maximum stability and to not obstruct the eyes of the infant (FIG. 14b).

Some earpiece embodiments may attach to a full circular headband via a silicone button. A small hole in the neoprene or other headband fabric may allow the button to slip through a portion of the headband and the button may be held snug by headband fabric or other materials of the headband. The button attachment may allow for the angle of the earpieces to be adjusted for proper placement around the ear (FIG. 14b).

### Cap

The cap may be a soft beanie-style embodiment made of various materials including mesh, cotton, polyester, and/or spandex. The cap may secure the earpieces against creating light pressure so the earpieces stay in proper position over the ears (FIG. 15). The cap may be secured with a chin strap.

Some earpiece embodiments may attach to the cap via the silicone button. A reinforced hole cap fabric, which may be a small hole, may allow the button to slip through the cap and may be held snug. The button attachment may allow for the angle of the earpieces to be adjusted for proper placement around the ear. The silicone button attachment may replace the velcro attachment seen in the original embodiment (FIG. 15).

The disclosure contemplates various combinations of the claims as well as various incorporation of disclosed matter.

The foregoing description, for purpose of explanation, has been described with reference to specific embodiments. However, the illustrative discussions above are not intended to be exhaustive or to limit the invention to the precise forms disclosed. Many modifications and variations are possible in view of the above teachings. The embodiments were chosen and described in order to best explain the principles of the invention and its practical applications, to thereby enable others skilled in the art to best utilize the invention and various embodiments with various modifications as are suited to the particular use contemplated.

| Reference | |
|---|---|
| Number | Exemplary Part name |
| 100 | sound attenuating assembly |
| 102 | concave member |
| 104 | compressible member |
| 106 | dividing member |
| 108 | padded member |
| 300 | covering back portion |
| 302 | covering front portion |
| 304 | stitching |
| 320 | first front piece |
| 322 | second front piece |
| 324 | first back piece |
| 326 | second back piece |
| 400 | dampening assembly |
| 502 | chinstrap |
| 702 | patch |
| 704 | fastener |
| 800 | ear piece |
| 802 | button |
| 804 | silicone layer |
| 806 | foam layer |
| 900 | headband |
| 902 | inner support |
| 904 | first outer support |
| 906 | second outer support |
| 908 | forehead strap |
| 910 | another embodiment of a headband |
| 1000 | ear piece |
| 1001 | ear piece with only padding and one |
| | type of attennuating material |
| 1002 | ear piece with outer attenuating material, |
| | and the inner attenuating material is a |
| | composite of 1100 and 1104 |
| 1011 | ear piece, small size, low attenuation |
| 1012 | ear piece, small size, medium attennuation |
| 1013 | ear piece, small size, high attennuation |
| 1021 | ear piece, medium size, low attenuation |
| 1022 | ear piece, medium size, medium attenuation |
| 1023 | ear piece, medium size, high attenuation |
| 1031 | ear piece, large size, low attenuation |
| 1032 | ear piece, large size, medium attenuation |
| 1032 | ear piece, large size, high attenuation |
| 1100 | outer attenuating material |
| 1101 | button |
| 1102 | papdding member |
| 1104 | inner attenuating material |
| 1105 | composite attenuating material made |
| | of 1100 and 1104 |
| 2000 | another embodiment of an ear piece that |
| | has a plurality of peelable layers |
| 2100 | button that attaches to the headband |
| 2102 | padding member |
| 2104 | first attenuating layer (innermost attenuating layer) |
| 2106 | second attenuating layer (inner attenuating layer) |
| 2108 | third attenuating layer (inner attenuating layer) |
| 2110 | fourth attenuating layer (inner attenuating layer) |
| 2112 | fifth attenuating layer (outermost attenuating layer) |
| 2200 | embodiment of an attenuating layer |
| | (2104, 2106, 2108, 2110, 2112) that may made of |
| | one type of attenuating material |
| 2206 | a hole in the attenuating layer allowing the |
| | button to fit (may or may not have the hole) |
| 2220 | embodiment of an attenuating layer (2200) |
| | made of 2 layers of materials |
| 2222 | outer attennuating material |
| 2224 | inner attenuating material |
| 2226 | hole in the attenuating layers allowing |
| | the button to fit |
| 2240 | embodiment of a layer for 2000 that |
| | involves 2 separate sub layers |
| 2242 | first sub layer |
| 2244 | second sub layer |
| 2246 | hole for the button |
| 3000 | embodiment of the earpiece which consists |
| | of an outer permanent shell that is not |
| | replaced each time |
| 3100 | button to attach the earpiece to the headband |
| 3102 | padding member |
| 3104 | attenuating material |
| 3106 | outer permanent shell |
| 700a | first ear-adjacent location |
| 700b | second ear-adjacent location |
| 713a | right pocket |
| 713b | left pocket |
| [symbol] | [symbol] |
| [symbol] | [symbol] |
| [symbol] | [symbol] |
| [symbol] | [symbol] |
| [symbol] | [symbol] |
| [symbol] | [symbol] |
| [symbol] | [symbol] |
| [symbol] | [symbol] |
| [symbol] | [symbol] |
| [symbol] | [symbol] |
| [symbol] | [symbol] |
| [symbol] | [symbol] |
| [symbol] | [symbol] |
| [symbol] | [symbol] |
| [symbol] | [symbol] |
| [symbol] | [symbol] |
| [symbol] | [symbol] |
| [symbol] | [symbol] |
| [symbol] | [symbol] |
| [symbol] | [symbol] |
| [symbol] | [symbol] |
| [symbol] | [symbol] |
| [symbol] | [symbol] |
| [symbol] | [symbol] |
| [symbol] | [symbol] |
| [symbol] | [symbol] |
| [symbol] | [symbol] |
| [symbol] | [symbol] |
| [symbol] | [symbol] |
| [symbol] | [symbol] |
| [symbol] | [symbol] |
| [symbol] | [symbol] |
| [symbol] | [symbol] |
| [symbol] | [symbol] |
| [symbol] | [symbol] |
| [symbol] | [symbol] |
| [symbol] | [symbol] |
| [symbol] | [symbol] |
| [symbol] | [symbol] |
| [symbol] | [symbol] |
| [symbol] | [symbol] |
| [symbol] | [symbol] |
| [symbol] | [symbol] |
| [symbol] | [symbol] |
| [symbol] | [symbol] |
| [symbol] | [symbol] |
| [symbol] | [symbol] |
| [symbol] | [symbol] |
| [symbol] | [symbol] |
| [symbol] | [symbol] |
| [symbol] | [symbol] |
| [symbol] | [symbol] |
| [symbol] | [symbol] |
| [symbol] | [symbol] |
| [symbol] | [symbol] |
| [symbol] | [symbol] |
| [symbol] | [symbol] |
| [symbol] | [symbol] |
| [symbol] | [symbol] |
| [symbol] | [symbol] |
| [symbol] | [symbol] |
| [symbol] | [symbol] |
| [symbol] | [symbol] |
| [symbol] | [symbol] |
| [symbol] | [symbol] |
| [symbol] | [symbol] |
| [symbol] | [symbol] |
| [symbol] | [symbol] |
| [symbol] | [symbol] |
| [symbol] | [symbol] |
| [symbol] | [symbol] |
| [symbol] | [symbol] |
| [symbol] | [symbol] |
| [symbol] | [symbol] |
| [symbol] | [symbol] |
| [symbol] | [symbol] |
| [symbol] | [symbol] |
| [symbol] | [symbol] |
| [symbol] | [symbol] |
| [symbol] | [symbol] |
| [symbol] | [symbol] |
| [symbol] | [symbol] |
| [symbol] | [symbol] |
| [symbol] | [symbol] |
| [symbol] | [symbol] |
| [symbol] | [symbol] |
| [symbol] | [symbol] |
| [symbol] | [symbol] |
| [symbol] | [symbol] |
| [symbol] | [symbol] |
| [symbol] | [symbol] |
| [symbol] | [symbol] |
| [symbol] | [symbol] |
| [symbol] | [symbol] |
| [symbol] | [symbol] |
| [symbol] | [symbol] |
| [symbol] | [symbol] |
| [symbol] | [symbol] |
| [symbol] | [symbol] |
| [symbol] | [symbol] |
| [symbol] | [symbol] |
| [symbol] | [symbol] |
| [symbol] | [symbol] |
| [symbol] | [symbol] |
| [symbol] | [symbol] |
| [symbol] | [symbol] |
| [symbol] | [symbol] |
| [symbol] | [symbol] |
| [symbol] | [symbol] |
| [symbol] | [symbol] |
| [symbol] | [symbol] |
| [symbol] | [symbol] |
| [symbol] | [symbol] |
| [symbol] | [symbol] |
| [symbol] | [symbol] |
| [symbol] | [symbol] |
| [symbol] | [symbol] |
| [symbol] | [symbol] |
| [symbol] | [symbol] |
| [symbol] | [symbol] |
| [symbol] | [symbol] |
| [symbol] | [symbol] |
| [symbol] | [symbol] |
| [symbol] | [symbol] |
| [symbol] | [symbol] |
| [symbol] | [symbol] |
| [symbol] | [symbol] |
| [symbol] | [symbol] |
| [symbol] | [symbol] |
| [symbol] | [symbol] |
| [symbol] | [symbol] |
| [symbol] | [symbol] |
| [symbol] | [symbol] |
| [symbol] | [symbol] |
| [symbol] | [symbol] |
| [symbol] | [symbol] |
| [symbol] | [symbol] |
| [symbol] | [symbol] |
| [symbol] | [symbol] |
| [symbol] | [symbol] |
| [symbol] | [symbol] |
| [symbol] | [symbol] |
| [symbol] | [symbol] |
| [symbol] | [symbol] |
| [symbol] | [symbol] |
| [symbol] | [symbol] |
| [symbol] | [symbol] |
| [symbol] | [symbol] |
| [symbol] | [symbol] |
| [symbol] | [symbol] |
| [symbol] | [symbol] |
| [symbol] | [symbol] |
| [symbol] | [symbol] |
| [symbol] | [symbol] |
| [symbol] | [symbol] |
| [symbol] | [symbol] |
| [symbol] | [symbol] |
| [symbol] | [symbol] |
| [symbol] | [symbol] |
| [symbol] | [symbol] |
| [symbol] | [symbol] |
| [symbol] | [symbol] |
| [symbol] | [symbol] |
| [symbol] | [symbol] |
| [symbol] | [symbol] |
| [symbol] | [symbol] |
| [symbol] | [symbol] |
| [symbol] | [symbol] |
| [symbol] | [symbol] |
| [symbol] | [symbol] |
| [symbol] | [symbol] |
| [symbol] | [symbol] |
| [symbol] | [symbol] |
| [symbol] | [symbol] |
| [symbol] | [symbol] |
| [symbol] | [symbol] |
| [symbol] | [symbol] |
| [symbol] | [symbol] |
| [symbol] | [symbol] |
| [symbol] | [symbol] |
| [symbol] | [symbol] |
| [symbol] | [symbol] |
| [symbol] | [symbol] |
| [symbol] | [symbol] |
| [symbol] | [symbol] |
| [symbol] | [symbol] |
| [symbol] | [symbol] |
| [symbol] | [symbol] |
| [symbol] | [symbol] |
| [symbol] | [symbol] |
| [symbol] | [symbol] |
| [symbol] | [symbol] |
| [symbol] | [symbol] |
| [symbol] | [symbol] |
| [symbol] | [symbol] |
| [symbol] | [symbol] |
| [symbol] | [symbol] |
| [symbol] | [symbol] |
| [symbol] | [symbol] |
| [symbol] | [symbol] |
| [symbol] | [symbol] |
| [symbol] | [symbol] |
| [symbol] | [symbol] |
| [symbol] | [symbol] |
| [symbol] | [symbol] |
| [symbol] | [symbol] |
| [symbol] | [symbol] |
| [symbol] | [symbol] |
| [symbol] | [symbol] |
| [symbol] | [symbol] |
| [symbol] | [symbol] |
| [symbol] | [symbol] |
| [symbol] | [symbol] |
| [symbol] | [symbol] |
| [symbol] | [symbol] |
| [symbol] | [symbol] |
| [symbol] | [symbol] |
| [symbol] | [symbol] |
| [symbol] | [symbol] |
| [symbol] | [symbol] |
| [symbol] | [symbol] |
| [symbol] | [symbol] |
| [symbol] | [symbol] |
| [symbol] | [symbol] |
| [symbol] | [symbol] |
| [symbol] | [symbol] |
| [symbol] | [symbol] |
| [symbol] | [symbol] |
| [symbol] | [symbol] |
| [symbol] | [symbol] |
| [symbol] | [symbol] |
| [symbol] | [symbol] |
| [symbol] | [symbol] |
| [symbol] | [symbol] |
| [symbol] | [symbol] |
| [symbol] | [symbol] |
| [symbol] | [symbol] |
| [symbol] | [symbol] |
| [symbol] | [symbol] |
| [symbol] | [symbol] |
| [symbol] | [symbol] |
| [symbol] | [symbol] |
| [symbol] | [symbol] |
| [symbol] | [symbol] |
| [symbol] | [symbol] |
| [symbol] | [symbol] |
| [symbol] | [symbol] |
| [symbol] | [symbol] |
| [symbol] | [symbol] |
| [symbol] | [symbol] |
| [symbol] | [symbol] |
| [symbol] | [symbol] |
| [symbol] | [symbol] |
| [symbol] | [symbol] |
| [symbol] | [symbol] |
| [symbol] | [symbol] |
| [symbol] | [symbol] |
| [symbol] | [symbol] |
| [symbol] | [symbol] |
| [symbol] | [symbol] |
| [symbol] | [symbol] |
| [symbol] | [symbol] |
| [symbol] | [symbol] |
| [symbol] | [symbol] |
| [symbol] | [symbol] |
| [symbol] | [symbol] |
| [symbol] | [symbol] |
| [symbol] | [symbol] |
| [symbol] | [symbol] |
| [symbol] | [symbol] |
| [symbol] | [symbol] |
| [symbol] | [symbol] |
| [symbol] | [symbol] |
| [symbol] | [symbol] |
| [symbol] | [symbol] |
| [symbol] | [symbol] |
| [symbol] | [symbol] |
| [symbol] | [symbol] |
| [symbol] | [symbol] |
| [symbol] | [symbol] |
| [symbol] | [symbol] |
| [symbol] | [symbol] |
| [symbol] | [symbol] |
| [symbol] | [symbol] |
| [symbol] | [symbol] |
| [symbol] | [symbol] |
| [symbol] | [symbol] |
| [symbol] | [symbol] |
| [symbol] | [symbol] |
| [symbol] | [symbol] |
| [symbol] | [symbol] |
| [symbol] | [symbol] |
| [symbol] | [symbol] |
| [symbol] | [symbol] |
| [symbol] | [symbol] |
| [symbol] | [symbol] |
| [symbol] | [symbol] |
| [symbol] | [symbol] |
| [symbol] | [symbol] |
| [symbol] | [symbol] |
| [symbol] | [symbol] |
| [symbol] | [symbol] |
| [symbol] | [symbol] |
| [symbol] | [symbol] |
| [symbol] | [symbol] |
| [symbol] | [symbol] |
| [symbol] | [symbol] |
| [symbol] | [symbol] |
| [symbol] | [symbol] |
| [symbol] | [symbol] |
| [symbol] | [symbol] |
| [symbol] | [symbol] |
| [symbol] | [symbol] |
| [symbol] | [symbol] |
| [symbol] | [symbol] |
| [symbol] | [symbol] |
| [symbol] | [symbol] |
| [symbol] | [symbol] |
| [symbol] | [symbol] |
| [symbol] | [symbol] |
| [symbol] | [symbol] |
| [symbol] | [symbol] |
| [symbol] | [symbol] |
| [symbol] | [symbol] |
| [symbol] | [symbol] |
| [symbol] | [symbol] |
| [symbol] | [symbol] |
| [symbol] | [symbol] |
| [symbol] | [symbol] |
| [symbol] | [symbol] |
| [symbol] | [symbol] |
| [symbol] | [symbol] |
| [symbol] | [symbol] |
| [symbol] | [symbol] |
| [symbol] | [symbol] |
| [symbol] | [symbol] |
| [symbol] | [symbol] |
| [symbol] | [symbol] |
| [symbol] | [symbol] |
| [symbol] | [symbol] |
| [symbol] | [symbol] |
| [symbol] | [symbol] |
| [symbol] | [symbol] |
| [symbol] | [symbol] |
| [symbol] | [symbol] |
| [symbol] | [symbol] |
| [symbol] | [symbol] |
| [symbol] | [symbol] |
| [symbol] | [symbol] |
| [symbol] | [symbol] |
| [symbol] | [symbol] |
| [symbol] | [symbol] |
| [symbol] | [symbol] |
| [symbol] | [symbol] |
| [symbol] | [symbol] |
| [symbol] | [symbol] |
| [symbol] | [symbol] |
| [symbol] | [symbol] |
| [symbol] | [symbol] |
| [symbol] | [symbol] |
| [symbol] | [symbol] |
| [symbol] | [symbol] |
| [symbol] | [symbol] |
| [symbol] | [symbol] |
| [symbol] | [symbol] |
| [symbol] | [symbol] |
| [symbol] | [symbol] |
| [symbol] | [symbol] |
| [symbol] | [symbol] |
| [symbol] | [symbol] |
| [symbol] | [symbol] |
| [symbol] | [symbol] |
| [symbol] | [symbol] |
| [symbol] | [symbol] |
| [symbol] | [symbol] |
| [symbol] | [symbol] |
| [symbol] | [symbol] |
| [symbol] | [symbol] |
| [symbol] | [symbol] |
| [symbol] | [symbol] |
| [symbol] | [symbol] |
| [symbol] | [symbol] |
| [symbol] | [symbol] |
| [symbol] | [symbol] |
| [symbol] | [symbol] |
| [symbol] | [symbol] |
| [symbol] | [symbol] |
| [symbol] | [symbol] |
| [symbol] | [symbol] |
| [symbol] | [symbol] |
| [symbol] | [symbol] |
| [symbol] | [symbol] |
| [symbol] | [symbol] |
| [symbol] | [symbol] |
| [symbol] | [symbol] |
| [symbol] | [symbol] |
| [symbol] | [symbol] |
| [symbol] | [symbol] |
| [symbol] | [symbol] |
| [symbol] | [symbol] |
| [symbol] | [symbol] |
| [symbol] | [symbol] |
| [symbol] | [symbol] |
| [symbol] | [symbol] |
| [symbol] | [symbol] |
| [symbol] | [symbol] |
| [symbol] | [symbol] |
| [symbol] | [symbol] |
| [symbol] | [symbol] |
| [symbol] | [symbol] |
| [symbol] | [symbol] |
| [symbol] | [symbol] |
| [symbol] | [symbol] |
| [symbol] | [symbol] |
| [symbol] | [symbol] |
| [symbol] | [symbol] |
| [symbol] | [symbol] |
| [symbol] | [symbol] |
| [symbol] | [symbol] |
| [symbol] | [symbol] |
| [symbol] | [symbol] |
| [symbol] | [symbol] |
| [symbol] | [symbol] |
| [symbol] | [symbol] |
| [symbol] | [symbol] |
| [symbol] | [symbol] |
| [symbol] | [symbol] |
| [symbol] | [symbol] |
| [symbol] | [symbol] |
| [symbol] | [symbol] |
| [symbol] | [symbol] |
| [symbol] | [symbol] |
| [symbol] | [symbol] |
| [symbol] | [symbol] |
| [symbol] | [symbol] |
| [symbol] | [symbol] |
| [symbol] | [symbol] |
| [symbol] | [symbol] |
| [symbol] | [symbol] |
| [symbol] | [symbol] |
| [symbol] | [symbol] |
| [symbol] | [symbol] |
| [symbol] | [symbol] |
| [symbol] | [symbol] |
| [symbol] | [symbol] |
| [symbol] | [symbol] |
| [symbol] | [symbol] |
| [symbol] | [symbol] |
| [symbol] | [symbol] |
| [symbol] | [symbol] |
| [symbol] | [symbol] |
| [symbol] | [symbol] |
| [symbol] | [symbol] |
| [symbol] | [symbol] |
| [symbol] | [symbol] |
| [symbol] | [symbol] |
| [symbol] | [symbol] |
| [symbol] | [symbol] |
| [symbol] | [symbol] |
| [symbol] | [symbol] |
| [symbol] | [symbol] |
| [symbol] | [symbol] |
| [symbol] | [symbol] |
| [symbol] | [symbol] |
| [symbol] | [symbol] |
| [symbol] | [symbol] |
| [symbol] | [symbol] |
| [symbol] | [symbol] |
| [symbol] | [symbol] |
| [symbol] | [symbol] |
| [symbol] | [symbol] |
| [symbol] | [symbol] |
| [symbol] | [symbol] |
| [symbol] | [symbol] |
| [symbol] | [symbol] |
| [symbol] | [symbol] |
| [symbol] | [symbol] |
| [symbol] | [symbol] |
| [symbol] | [symbol] |
| [symbol] | [symbol] |
| [symbol] | [symbol] |
| [symbol] | [symbol] |
| [symbol] | [symbol] |
| [symbol] | [symbol] |
| [symbol] | [symbol] |
| [symbol] | [symbol] |
| [symbol] | [symbol] |
| [symbol] | [symbol] |
| [symbol] | [symbol] |
| [symbol] | [symbol] |
| [symbol] | [symbol] |
| [symbol] | [symbol] |
| [symbol] | [symbol] |
| [symbol] | [symbol] |
| [symbol] | [symbol] |
| [symbol] | [symbol] |
| [symbol] | [symbol] |
| [symbol] | [symbol] |
| [symbol] | [symbol] |
| [symbol] | [symbol] |
| [symbol] | [symbol] |
| [symbol] | [symbol] |
| [symbol] | [symbol] |
| [symbol] | [symbol] |
| [symbol] | [symbol] |
| [symbol] | [symbol] |
| [symbol] | [symbol] |
| [symbol] | [symbol] |
| [symbol] | [symbol] |
| [symbol] | [symbol] |
| [symbol] | [symbol] |
| [symbol] | [symbol] |
| [symbol] | [symbol] |
| [symbol] | [symbol] |
| [symbol] | [symbol] |
| [symbol] | [symbol] |
| [symbol] | [symbol] |
| [symbol] | [symbol] |
| [symbol] | [symbol] |
| [symbol] | [symbol] |
| [symbol] | [symbol] |
| [symbol] | [symbol] |
| [symbol] | [symbol] |
| [symbol] | [symbol] |
| [symbol] | [symbol] |
| [symbol] | [symbol] |
| [symbol] | [symbol] |
| [symbol] | [symbol] |
| [symbol] | [symbol] |
| [symbol] | [symbol] |
| [symbol] | [symbol] |
| [symbol] | [symbol] |
| [symbol] | [symbol] |
| [symbol] | [symbol] |
| [symbol] | [symbol] |
| [symbol] | [symbol] |
| [symbol] | [symbol] |
| [symbol] | [symbol] |
| [symbol] | [symbol] |
| [symbol] | [symbol] |
| [symbol] | [symbol] |
| [symbol] | [symbol] |
| [symbol] | [symbol] |
| [symbol] | [symbol] |
| [symbol] | [symbol] |
| [symbol] | [symbol] |
| [symbol] | [symbol] |
| [symbol] | [symbol] |
| [symbol] | [symbol] |
| [symbol] | [symbol] |
| [symbol] | [symbol] |
| [symbol] | [symbol] |
| [symbol] | [symbol] |
| [symbol] | [symbol] |
| [symbol] | [symbol] |
| [symbol] | [symbol] |
| [symbol] | [symbol] |
| [symbol] | [symbol] |
| [symbol] | [symbol] |
| [symbol] | [symbol] |
| [symbol] | [symbol] |
| [symbol] | [symbol] |
| [symbol] | [symbol] |
| [symbol] | [symbol] |
| [symbol] | [symbol] |
| [symbol] | [symbol] |
| [symbol] | [symbol] |
| [symbol] | [symbol] |
| [symbol] | [symbol] |
| [symbol] | [symbol] |
| [symbol] | [symbol] |
| [symbol] | [symbol] |
| [symbol] | [symbol] |
| [symbol] | [symbol] |
| [symbol] | [symbol] |
| [symbol] | [symbol] |
| [symbol] | [symbol] |
| [symbol] | [symbol] |
| [symbol] | [symbol] |
| [symbol] | [symbol] |
| [symbol] | [symbol] |
| [symbol] | [symbol] |
| [symbol] | [symbol] |
| [symbol] | [symbol] |
| [symbol] | [symbol] |
| [symbol] | [symbol] |
| [symbol] | [symbol] |
| [symbol] | [symbol] |
| [symbol] | [symbol] |
| [symbol] | [symbol] |
| [symbol] | [symbol] |
| [symbol] | [symbol] |
| [symbol] | [symbol] |
| [symbol] | [symbol] |
| [symbol] | [symbol] |
| [symbol] | [symbol] |
| [symbol] | [symbol] |
| [symbol] | [symbol] |
| [symbol] | [symbol] |
| [symbol] | [symbol] |
| [symbol] | [symbol] |
| [symbol] | [symbol] |
| [symbol] | [symbol] |
| [symbol] | [symbol] |
| [symbol] | [symbol] |
| [symbol] | [symbol] |
| [symbol] | [symbol] |
| [symbol] | [symbol] |
| [symbol] | [symbol] |
| [symbol] | [symbol] |
| [symbol] | [symbol] |
| [symbol] | [symbol] |
| [symbol] | [symbol] |
| [symbol] | [symbol] |
| [symbol] | [symbol] |
| [symbol] | [symbol] |
| [symbol] | [symbol] |
| [symbol] | [symbol] |
| [symbol] | [symbol] |
| [symbol] | [symbol] |
| [symbol] | [symbol] |
| [symbol] | [symbol] |
| [symbol] | [symbol] |
| [symbol] | [symbol] |
| [symbol] | [symbol] |
| [symbol] | [symbol] |
| [symbol] | [symbol] |
| [symbol] | [symbol] |
| [symbol] | [symbol] |
| [symbol] | [symbol] |
| [symbol] | [symbol] |
| [symbol] | [symbol] |
| [symbol] | [symbol] |
| [symbol] | [symbol] |
| [symbol] | [symbol] |
| [symbol] | [symbol] |
| [symbol] | [symbol] |
| [symbol] | [symbol] |
| [symbol] | [symbol] |
| [symbol] | [symbol] |
| [symbol] | [symbol] |
| [symbol] | [symbol] |
| [symbol] | [symbol] |
| [symbol] | [symbol] |
| [symbol] | [symbol] |
| [symbol] | [symbol] |
| [symbol] | [symbol] |
| [symbol] | [symbol] |
| [symbol] | [symbol] |
| [symbol] | [symbol] |
| [symbol] | [symbol] |
| [symbol] | [symbol] |
| [symbol] | [symbol] |
| [symbol] | [symbol] |
| [symbol] | [symbol] |
| [symbol] | [symbol] |
| [symbol] | [symbol] |
| [symbol] | [symbol] |
| [symbol] | [symbol] |
| [symbol] | [symbol] |
| [symbol] | [symbol] |
| [symbol] | [symbol] |
| [symbol] | [symbol] |
| [symbol] | [symbol] |
| [symbol] | [symbol] |
| [symbol] | [symbol] |
| [symbol] | [symbol] |
| [symbol] | [symbol] |
| [symbol] | [symbol] |
| [symbol] | [symbol] |
| [symbol] | [symbol] |
| [symbol] | [symbol] |
| [symbol] | [symbol] |
| [symbol] | [symbol] |
| [symbol] | [symbol] |
| [symbol] | [symbol] |
| [symbol] | [symbol] |
| [symbol] | [symbol] |
| [symbol] | [symbol] |
| [symbol] | [symbol] |
| [symbol] | [symbol] |
| [symbol] | [symbol] |
| [symbol] | [symbol] |
| [symbol] | [symbol] |
| [symbol] | [symbol] |
| [symbol] | [symbol] |
| [symbol] | [symbol] |
| [symbol] | [symbol] |
| [symbol] | [symbol] |
| [symbol] | [symbol] |
| [symbol] | [symbol] |
| [symbol] | [symbol] |
| [symbol] | [symbol] |
| [symbol] | [symbol] |
| [symbol] | [symbol] |
| [symbol] | [symbol] |
| [symbol] | [symbol] |
| [symbol] | [symbol] |
| [symbol] | [symbol] |
| [symbol] | [symbol] |
| [symbol] | [symbol] |
| [symbol] | [symbol] |
| [symbol] | [symbol] |
| [symbol] | [symbol] |
| [symbol] | [symbol] |
| [symbol] | [symbol] |
| [symbol] | [symbol] |
| [symbol] | [symbol] |
| [symbol] | [symbol] |
| [symbol] | [symbol] |
| [symbol] | [symbol] |
| [symbol] | [symbol] |
| [symbol] | [symbol] |
| [symbol] | [symbol] |
| [symbol] | [symbol] |
| [symbol] | [symbol] |
| [symbol] | [symbol] |
| [symbol] | [symbol] |
| [symbol] | [symbol] |
| [symbol] | [symbol] |
| [symbol] | [symbol] |
| [symbol] | [symbol] |
| [symbol] | [symbol] |
| [symbol] | [symbol] |
| [symbol] | [symbol] |
| [symbol] | [symbol] |
| [symbol] | [symbol] |
| [symbol] | [symbol] |
| [symbol] | [symbol] |
| [symbol] | [symbol] |
| [symbol] | [symbol] |
| [symbol] | [symbol] |
| [symbol] | [symbol] |
| [symbol] | [symbol] |
| [symbol] | [symbol] |
| [symbol] | [symbol] |
| [symbol] | [symbol] |
| [symbol] | [symbol] |
| [symbol] | [symbol] |
| [symbol] | [symbol] |
| [symbol] | [symbol] |
| [symbol] | [symbol] |
| [symbol] | [symbol] |
| [symbol] | [symbol] |
| [symbol] | [symbol] |
| [symbol] | [symbol] |
| [symbol] | [symbol] |
| [symbol] | [symbol] |
| [symbol] | [symbol] |
| [symbol] | [symbol] |
| [symbol] | [symbol] |
| [symbol] | [symbol] |
| [symbol] | [symbol] |
| [symbol] | [symbol] |
| [symbol] | [symbol] |
| [symbol] | [symbol] |
| [symbol] | [symbol] |
| [symbol] | [symbol] |
| [symbol] | [symbol] |
| [symbol] | [symbol] |
| [symbol] | [symbol] |
| [symbol] | [symbol] |
| [symbol] | [symbol] |
| [symbol] | [symbol] |
| [symbol] | [symbol] |
| [symbol] | [symbol] |
| [symbol] | [symbol] |
| [symbol] | [symbol] |
| [symbol] | [symbol] |
| [symbol] | [symbol] |
| [symbol] | [symbol] |
| [symbol] | [symbol] |
| [symbol] | [symbol] |
| [symbol] | [symbol] |
| [symbol] | [symbol] |
| [symbol] | [symbol] |
| [symbol] | [symbol] |
| [symbol] | [symbol] |
| [symbol] | [symbol] |
| [symbol] | [symbol] |
| [symbol] | [symbol] |
| [symbol] | [symbol] |
| [symbol] | [symbol] |
| [symbol] | [symbol] |
| [symbol] | [symbol] |
| [symbol] | [symbol] |
| [symbol] | [symbol] |
| [symbol] | [symbol] |
| [symbol] | [symbol] |
| [symbol] | [symbol] |
| [symbol] | [symbol] |
| [symbol] | [symbol] |
| [symbol] | [symbol] |
| [symbol] | [symbol] |
| [symbol] | [symbol] |
| [symbol] | [symbol] |
| [symbol] | [symbol] |
| [symbol] | [symbol] |
| [symbol] | [symbol] |
| [symbol] | [symbol] |
| [symbol] | [symbol] |
| [symbol] | [symbol] |
| [symbol] | [symbol] |
| [symbol] | [symbol] |
| [symbol] | [symbol] |
| [symbol] | [symbol] |
| [symbol] | [symbol] |
| [symbol] | [symbol] |
| [symbol] | [symbol] |
| [symbol] | [symbol] |
| [symbol] | [symbol] |
| [symbol] | [symbol] |
| [symbol] | [symbol] |
| [symbol] | [symbol] |
| [symbol] | [symbol] |
| [symbol] | [symbol] |
| [symbol] | [symbol] |
| [symbol] | [symbol] |
| [symbol] | [symbol] |
| [symbol] | [symbol] |
| [symbol] | [symbol] |
| [symbol] | [symbol] |
| [symbol] | [symbol] |
| [symbol] | [symbol] |
| [symbol] | [symbol] |
| [symbol] | [symbol] |
| [symbol] | [symbol] |
| [symbol] | [symbol] |
| [symbol] | [symbol] |
| [symbol] | [symbol] |
| [symbol] | [symbol] |
| [symbol] | [symbol] |
| [symbol] | [symbol] |
| [symbol] | [symbol] |
| [symbol] | [symbol] |
| [symbol] | [symbol] |
| [symbol] | [symbol] |
| [symbol] | [symbol] |
| [symbol] | [symbol] |
| [symbol] | [symbol] |
| [symbol] | [symbol] |
| [symbol] | [symbol] |
| [symbol] | [symbol] |
| [symbol] | [symbol] |
| [symbol] | [symbol] |
| [symbol] | [symbol] |
| [symbol] | [symbol] |
| [symbol] | [symbol] |
| [symbol] | [symbol] |
| [symbol] | [symbol] |
| [symbol] | [symbol] |
| [symbol] | [symbol] |
| [symbol] | [symbol] |
| [symbol] | [symbol] |
| [symbol] | [symbol] |
| [symbol] | [symbol] |
| [symbol] | [symbol] |
| [symbol] | [symbol] |
| [symbol] | [symbol] |
| [symbol] | [symbol] |
| [symbol] | [symbol] |
| [symbol] | [symbol] |
| [symbol] | [symbol] |
| [symbol] | [symbol] |
| [symbol] | [symbol] |
| [symbol] | [symbol] |
| [symbol] | [symbol] |
| [symbol] | [symbol] |
| [symbol] | [symbol] |
| [symbol] | [symbol] |
| [symbol] | [symbol] |
| [symbol] | [symbol] |
| [symbol] | [symbol] |
| [symbol] | [symbol] |
| [symbol] | [symbol] |
| [symbol] | [symbol] |
| [symbol] | [symbol] |
| [symbol] | [symbol] |
| [symbol] | [symbol] |
| [symbol] | [symbol] |
| [symbol] | [symbol] |
| [symbol] | [symbol] |
| [symbol] | [symbol] |
| [symbol] | [symbol] |
| [symbol] | [symbol] |
| [symbol] | [symbol] |
| [symbol] | [symbol] |
| [symbol] | [symbol] |
| [symbol] | [symbol] |
| [symbol] | [symbol] |
| [symbol] | [symbol] |
| [symbol] | [symbol] |
| [symbol] | [symbol] |
| [symbol] | [symbol] |
| [symbol] | [symbol] |
| [symbol] | [symbol] |
| [symbol] | [symbol] |
| [symbol] | [symbol] |
| [symbol] | [symbol] |
| [symbol] | [symbol] |
| [symbol] | [symbol] |
| [symbol] | [symbol] |
| [symbol] | [symbol] |
| [symbol] | [symbol] |
| [symbol] | [symbol] |
| [symbol] | [symbol] |
| [symbol] | [symbol] |
| [symbol] | [symbol] |
| [symbol] | [symbol] |
| [symbol] | [symbol] |
| [symbol] | [symbol] |
| [symbol] | [symbol] |
| [symbol] | [symbol] |
| [symbol] | [symbol] |
| [symbol] | [symbol] |
| [symbol] | [symbol] |
| [symbol] | [symbol] |
| [symbol] | [symbol] |
| [symbol] | [symbol] |
| [symbol] | [symbol] |
| [symbol] | [symbol] |
| [symbol] | [symbol] |
| [symbol] | [symbol] |
| [symbol] | [symbol] |
| [symbol] | [symbol] |
| [symbol] | [symbol] |
| [symbol] | [symbol] |
| [symbol] | [symbol] |
| [symbol] | [symbol] |

[symbol]

indicates data missing or illegible when filed

1. A neonatal sound attenuation system for attenuating sound in a first ear of a neonatal user and in a second year of a neonatal user comprising:
a headpiece configured to be worn by a neonatal user;
a first sound-attenuating earpiece assembly; and,
a second sound-attenuating earpiece assembly.

2. The neonatal sound attenuation system of claim 1, wherein the first sound-attenuating earpiece assembly comprises:
an outer shell made of a firm material and configured in a concave shape to surround the user's ear;
an amount of padding surrounding the user's ear; and,
an internal attenuating material positioned within the outer shell, wherein the attenuating material is composed of foam or composite material;
wherein the second sound-attenuating earpiece assembly comprises:
an outer shell made of a firm material and configured in a concave shape to surround the user's ear;
an amount of padding surrounding the user's ear; and,
an internal attenuating material positioned within the outer shell, wherein the attenuating material is composed of foam or composite material.

3. The neonatal sound attenuation system of claim 1,
the first sound-attenuating earpiece assembly further comprising a first dampening layer comprising material selected from silicone, wherein the first dampening layer is coupled to a second dampening layer comprising material selected from viscoelastic and foam; wherein the second dampening layer is concave shaped and extends radially beyond the first dampening layer; and,
the second sound-attenuating earpiece assembly further comprising a first dampening layer comprising material selected from silicone, wherein the first dampening layer is coupled to a second dampening layer comprising material selected from viscoelastic and foam; wherein the second dampening layer is concave shaped and extends radially beyond the first dampening layer.

4. The neonatal sound attenuation system of claim 1, further comprising:
wherein the first sound-attenuating earpiece assembly comprises a button-stem assembly; wherein a button of the button-stem assembly is coupled to an outer edge of an opening element defining a first opening of the headpiece, wherein the stem of the button-stem comprises a major longitudinal axis and is rotatably coupled to a first portion of a headpiece wherein the first sound-attenuating assembly is rotatable about the major longitudinal axis; and,
wherein the second sound-attenuating earpiece assembly comprises a button-stem assembly; wherein the button of the button-stem assembly is coupled to an outer edge of an opening element defining a first opening of the headpiece, wherein the stem of the button-stem comprises a major longitudinal axis and is rotatably coupled to a second portion of the headpiece wherein the first sound-attenuating assembly is rotatable about the major longitudinal axis.

5. The neonatal sound attenuation system of claim 1, wherein:
the headpiece comprises a mesh net or a flexible material designed to maintain comfort and stability on a neonatal user's head.

6. The neonatal sound attenuation system of claim 4, wherein:
the first portion of the headpiece is extendably coupled to a third portion of the headpiece via a first slidable bar, wherein the third portion of the headpiece securely and slidably surrounds the first slidable bar having a compressible-expandable tip, wherein the third portion of the headpiece further comprises a first lip configured to frictionally prevent the compressible-expandable tip from moving beyond the first lip when a mature user pulls on the first portion of the headpiece without exertion, wherein the first portion of the headpiece is configured to securely position the first sound-attenuating earpiece against the first ear of the user; and,
The second portion of the headpiece is extendably coupled to a fourth portion of the headpiece via a second slidable bar, wherein the fourth portion of the headpiece securely and slidably surrounds the second slidable bar having a compressible-expandable tip, wherein the fourth portion of the headpiece further comprises a second lip configured to frictionally prevent the compressible-expandable tip from moving beyond the second lip when a mature user pulls on the second portion of the headpiece without exertion, wherein the second portion of the headpiece is configured to securely position the second sound-attenuating earpiece against the second ear of the user.

7. The neonatal sound attenuation system of claim 1, wherein:
the first sound-attenuating assembly is configured to provide maximum sound attenuation to the neonatal user;
a third sound attenuating assembly, swappable with the first sound-attenuating assembly and swappable with a fourth sound-attenuating assembly, is configured to provide medium sound-attenuation to the neonatal user;
a fourth attenuating assembly, swappable with the first sound-attenuating assembly and swappable with the third sound-attenuating assembly, is configured to provide minimal sound-attenuation to the neonatal user.

8. The neonatal sound attenuation system of claim 5, wherein:
the first sound-attenuating assembly is configured such that a sound-attenuation level is adjustable when a mature user removably peels off at least one sound-attenuating layer, of the first sound-attenuating assembly, to achieve medium attenuation for the neonatal user and such that the sound-attenuation level is further adjustable when a mature user removably peels off at least one sound-attenuating layer, of the first sound-attenuating assembly, to achieve low-sound attenuation for the neonatal user.

9. The neonatal sound attenuation system of claim 6, wherein:
a total number of removable attenuating layers is greater than three, allowing for finer control over sound attenuation levels.

10. The neonatal sound attenuation system of claim 1, wherein:
an inner attenuating material comprises viscoelastic foam or antimicrobial polyurethane foam.

11. The neonatal sound attenuation system of claim 1, wherein:
a plurality of attenuating layers comprises:
a durable sound-attenuating silicone-based outer layer;
a middle sound-attenuating composite layer; and,
an inner sound-attenuating viscoelastic layer.

12. A method for neonatal sound attenuation comprising:
wherein a first sound-attenuating assembly is configured to provide maximum sound attenuation to the neonatal user;
providing a first sound-attenuating earpiece assembly comprising:
an outer shell made of a firm material and configured in a concave shape to surround an ear of the neonatal user;
an amount of padding surrounding the ear of the neonatal user; and,
an internal attenuating material positioned within the outer shell, wherein the attenuating material is composed of foam or composite material;
securing the headpiece onto a neonatal user; and,
adjusting the sound-attenuating earpiece assembly to ensure proper fit and sound-proper attenuation for the neonatal user.

13. The method of claim 12, further comprising:
waiting until the neonatal user is at least 33 weeks old as calculated by gestational age;
securing to at least one ear of a neonatal user a third sound-attenuating assembly, swappable with the first sound-attenuating assembly and swappable with a fourth sound-attenuating assembly, wherein the third sound-attenuating assembly is configured to provide medium sound-attenuation to the neonatal user;
waiting until the neonatal user is full term gestational age;
securing to the at least one ear of the neonatal user a fourth sound-attenuating assembly, swappable with the first sound-attenuating assembly and swappable with the third sound-attenuating assembly, wherein the fourth sound-attenuating assembly is configured to provide minimal sound-attenuation to the neonatal user.

14. A method for using a customizable neonatal sound attenuation system comprising:
providing a neonatal sound attenuation system comprising
a headpiece configured to be worn by a neonatal user;
a first portion of the headpiece is extendably coupled to a third portion of the headpiece via a first slidable bar, wherein the third portion of the headpiece securely and slidably surrounds the first slidable bar having a compressible-expandable tip, wherein the third portion of the headpiece further comprises a first lip configured to frictionally prevent the compressible-expandable tip from moving beyond the first lip when a mature user pulls on the first portion of the headpiece without exertion, wherein the first portion of the headpiece is configured to securely position a first sound-attenuating earpiece against a first ear of the user;
a second portion of the headpiece is extendably coupled to a fourth portion of the headpiece via a second slidable bar, wherein the fourth portion of the headpiece securely and slidably surrounds the second slidable bar having a compressible-expandable tip, wherein the fourth portion of the headpiece further comprises a second lip configured to frictionally prevent the compressible-expandable tip from moving beyond the second lip when a mature user pulls on the second portion of the headpiece without exertion, wherein the second portion of the headpiece is configured to securely position the second sound-attenuating earpiece against the second ear of the user; and,
a first sound-attenuating earpiece assembly comprising removable attenuating layers for a first ear of the neonatal user; and,
a second sound-attenuating earpiece assembly comprising removable attenuating layers for the second ear of the neonatal user;
waiting until the neonatal user is at least 33 weeks gestational age;
peeling off at least one attenuating layer to reduce attenuation to a mid-level;
waiting until the neonatal user is at least full-term gestational age; and,
peeling off an additional layer to further reduce attenuation of sounds to below 4000 Hz in an average environment of the neonatal user.
